(19) United States
(12) Patent Application Publication
(10) Pub. No.: US 2018/0324854 A1
(43) Pub. Date: Nov. 8, 2018

(54) UPLINK SMALL DATA TRANSMISSION FOR ENHANCED MACHINE-TYPE-COMMUNICATION (EMTC) AND INTERNET OF THINGS (IOT) COMMUNICATION

(71) Applicant: QUALCOMM INCORPORATED, SAN DIEGO, CA (US)

(72) Inventors: Umesh PHUYAL, San Diego, CA (US); Alberto RICO ALVARINO, San Diego, CA (US); Mungal Singh DHANDA, Slough (GB); Miguel GRIOT, La Jolla, CA (US); Peter GAAL, San Diego, CA (US)

(21) Appl. No.: 15/964,523

(22) Filed: Apr. 27, 2018

Related U.S. Application Data
(60) Provisional application No. 62/501,358, filed on May 4, 2017.

(51) Int. Cl. H04W 74/08; H04W 74/04

(52) U.S. Cl. CPC H04W 74/085; H04W 84/045; H04W 74/04

(57) ABSTRACT

A method includes sending communication data from a user equipment (UE) to a base station (eNB) during a random access procedure prior to establishment of a radio resource control (RRC) connection between the UE and the base station. Methods may allow a UE to use a message 1 (Msg1) communication or a message 3 (Msg3) communication to send data to a base station prior to the establishment of the RRC connection between the UE and the base station. Other aspects, embodiments, and features are also claimed and described.

### RELATED APPLICATIONS

This application claims priority to and the benefit of U.S. Provisional Patent Application No. 62/501,358, entitled “Uplink Small Data Transmission For Enhanced Machine-Type-Communication (EMTC) And Internet Of Things (IOT) Communication,” filed May 4, 2017, the contents of which are hereby incorporated herein by reference in its entirety as if fully set forth below and for all applicable purposes.

### TECHNICAL FIELD

The technology discussed below relates to wireless communication systems, and more particularly, to an uplink communication channel for enhanced machine-type-communication. Embodiments enable and provide an efficient uplink communication techniques for enhanced machine-type-communication and IoT communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., spectrum, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE) or LTE-Advanced (LTE-A). Another example of a telecommunication standard is 5G, sometimes referred to as new radio (NR).

Wireless communications devices, sometimes referred to as user equipment (UE), may communicate with a base station or may communicate directly with other UEs. When a UE communicates directly with another UE, the communication is referred to as device-to-device (D2D) communication. In particular use cases, a UE may be a wireless communication device, such as a portable cellular device, or may be a vehicle, a drone, an appliance, a sensor, or may be any other connected device.

A type of communication that generally exchanges small amounts of information is referred to as machine-type-communication (MTC). Machine-type-communication generally refers to communications that are characterized by automatic data generation, exchange, processing, and actuation among machines with little or no human intervention.

The Internet of things (IoT) is the inter-networking of physical devices, vehicles (sometimes referred to as “connected devices” and/or “smart devices”), buildings, and other items that may have embedded electronics, software, sensors, actuators, and network connectivity that enable these objects to collect and exchange data and other information.

Many MTC and IoT communication applications involve the relatively infrequent exchange of small amounts of data. Minimizing overhead for each exchange of data can aid in reducing resources used in MTC and IoT communication.

### BRIEF SUMMARY

Various implementations of systems, methods and devices within the scope of the appended claims each have several aspects, no single one of which is solely responsible for the desirable attributes described herein. This summary is not an extensive overview of all contemplated features of the disclosure, and is intended neither to identify key or critical elements of all aspects of the disclosure nor to delineate the scope of any or all aspects of the disclosure. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Relative dimensions of the following figures may not be drawn to scale.

One aspect of the disclosure provides a method for communication. Method embodiments include sending communication data from a user equipment (UE) to a base station (eNB) during a random access procedure prior to establishment of a radio resource control (RRC) connection between the UE and the base station.

Another aspect of the disclosure provides an apparatus for communication including a user Equipment (UE) configured to send communication data to a base station (eNB) during a random access procedure prior to establishment of a radio resource control (RRC) connection is between the UE and the base station.

Another aspect of the disclosure provides a device including means for sending communication information data from a user equipment (UE) to a base station (eNB) during a random access procedure prior to establishment of a radio resource control (RRC) connection is between the UE and the base station.

Another aspect of the disclosure provides a non-transitory computer-readable medium storing computer executable code for communication, the code executable by a processor to send communication data from a user equipment (UE) to a base station (eNB) during a random access procedure prior to establishment of a radio resource control (RRC) connection is between the UE and the base station.

Another aspect of the disclosure provides a method for a random access communication. Method embodiments include, in a random access procedure, sending a first communication message from a user equipment (UE) to a base station (eNB), in the random access procedure, receiving from the base station a second communication message having an uplink communication grant defining a communication data resource, and in the random access procedure, sending in a third communication message from the UE, communication data using the defined communication data resource prior to the establishment of a radio resource communication (RRC) link.

Other aspects, features, and embodiments of the technology will become apparent to those of ordinary skill in the art, upon reviewing the following description of specific, exemplary embodiments in conjunction with the accompanying figures. While features of the technology discussed below may be described relative to certain embodiments and figures below, all embodiments can include one or more of the advantageous features discussed. While one or more embodiments may be discussed as having certain advantageous features, one or more of such features may also be used in accordance with the various embodiments discussed. In similar fashion, while exemplary embodiments may be discussed below as device, system, or method embodiments it should be understood that such exemplary embodiments can be implemented in varying shapes, sizes, layouts, arrangements, circuits, devices, systems, and methods.

### BRIEF DESCRIPTION OF THE DRAWINGS

In the figures, like reference numerals refer to like parts throughout the various views unless otherwise indicated. For reference numerals with letter character designations such as “102a” or “102b”, the letter character designations may differentiate two like parts or elements present in the same figure. Letter character designations for reference numerals may be omitted when it is intended that a reference numeral encompass all parts having the same reference numeral in all figures.

FIG. 1 is a diagram illustrating an example of a cellular communication system architecture, in accordance with various aspects of the present disclosure.

FIG. 2 is a diagram illustrating an example of a cellular access network, in accordance with various aspects of the present disclosure.

FIG. 3 is a diagram illustrating an example of a DL frame structure in LTE, in accordance with various aspects of the present disclosure.

FIG. 4 is a diagram illustrating an example of an UL frame structure in LTE, in accordance with various aspects of the present disclosure.

FIG. 5 is a diagram illustrating an example of a radio protocol architecture for the user and control planes in accordance with various aspects of the present disclosure.

FIG. 6 is a diagram illustrating an example of an evolved Node B and user equipment in an access network in accordance with various aspects of the present disclosure.

FIG. 7 is a diagram illustrating a communication system in accordance with various aspects of the present disclosure.

FIGS. 8A, 8B, and 8C are diagrams illustrating narrowband operation of MTC UEs in a large bandwidth allocated for non-MTC UEs in accordance with various aspects of the present disclosure.

FIG. 9 is a diagram showing an exemplary embodiment of an (N)PRACH communication for use in sending data using Msg1 in accordance with various aspects of the present disclosure.

FIG. 10 is a call flow diagram showing call flow for a UE using Msg3 to send data to a base station, in accordance with various aspects of the present disclosure.

FIG. 11 is a call flow diagram showing call flow for a UE using Msg3 to send data to a base station including an exemplary embodiment of enhanced acknowledgement, in accordance with various aspects of the present disclosure.

FIG. 12A is a call flow diagram showing call flow for a UE using Msg3 to send data to a base station including an exemplary embodiment of enhanced security, in accordance with various aspects of the present disclosure.

FIG. 12B is a call flow diagram showing an alternative exemplary call flow for a UE using Msg3 to send data to a base station including an exemplary embodiment of enhanced security, in accordance with various aspects of the present disclosure.

FIG. 13 is a call flow diagram showing call flow for a UE using Msg3 to send data to a base station including an exemplary embodiment of enhanced security, in accordance with various aspects of the present disclosure.

FIG. 14 is a call flow diagram showing call flow for a UE using Msg3 to send data to a base station, in accordance with various aspects of the present disclosure.

FIG. 15 is a call flow diagram showing call flow for a UE using a first communication message to send data to a base station, in accordance with various aspects of the present disclosure.

FIG. 16 is a flow chart illustrating an example of a method for communication, in accordance with various aspects of the present disclosure.

FIG. 17 is a functional block diagram of an apparatus for communication in accordance with various aspects of the present disclosure.

FIG. 18 is a flow chart illustrating an example of a method for communication, in accordance with various aspects of the present disclosure.

FIG. 19 is a flow chart illustrating an example of a method for communication, in accordance with various aspects of the present disclosure.

FIG. 20 is flow chart illustrating an example of a method for communication, in accordance with various aspects of the present disclosure.

FIG. 21 is a flow chart illustrating an example of a method for communication, in accordance with various aspects of the present disclosure.

FIG. 22 is a flow chart illustrating an example of a method for communication, in accordance with various aspects of the present disclosure.

FIG. 23 is a flow chart illustrating an example of a method for communication, in accordance with various aspects of the present disclosure.

### DETAILED DESCRIPTION

The word “exemplary” is used herein to mean “serving as an example, instance, or illustration.” Any aspect described herein as “exemplary” is not necessarily to be construed as preferred or advantageous over other aspects.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Exemplary embodiments of the disclosure are directed to MTC and IoT communications. These example communication types may can use, for example, a random access procedure. This type of procedure may involve use of a communication preamble to send data from a UE to a base station. Doing so can enable transmissions without waiting to establish a radio resource control (RRC) communication channel between a UE and a base station. Exemplary embodiments of the disclosure are also directed to LTE, 5G, or other wide area network (WAN) communications. In an exemplary embodiment, the random access procedure having the communication preamble may comprise the initial symbols of a random access procedure, such as a physical random access channel (PRACH), a physical uplink shared channel (PUSCH), a narrowband PUSCH (NPUSCH) or, in an alternative exemplary embodiment, a narrowband PRACH (NPRACH), or any random access procedure or physical random access channel communication.

Communication may include a number of messages. For example, the communication of data from the UE to the base station may occur in the first UE communication to the base station, referred to as message 1 (Msg1) and/or the second communication from the UE to the base station, also referred to as message 3 (Msg3) of the communication. In an exemplary embodiment, the first UE communication to the base station (Msg1) and/or the second communication from the UE to the base station (Msg3) may occur prior to the establishment of an RRC communication channel between the UE and the base station. In an exemplary embodiment, the first communication from a base station to a UE is referred to as message 2 (Msg2). In an exemplary embodiment, the first message (Msg1) during a random access procedure contains a preamble, while other messages during the random access procedure do not. Further, there can be cases where messages are re-transmitted by components sending the messages (e.g., a UE may resend the first message (Msg1)).

In an exemplary embodiment, the term “data transmission in Msg1” and the term “data transmission in Msg3” may also separately or collectively be referred to as “early data transmission” to refer to data transmission from a UE prior to the establishment of an RRC connection between a UE and a base station.

In an exemplary embodiment, MTC/IoT applications may include mobile originated (MO) communications, such as metering, alarm, or other mobile originated communications; and/or mobile terminated (MT) communications, such as queries, notifications of update, position of actuators, etc. These and other communications involve the infrequent exchange of small amounts of data. Therefore, awaiting the establishment of an RRC communication channel may involve a significant amount of overhead that, in some instances, may be larger than the data sought to be transmitted. For example, for MT data, establishing the RRC communication channel may use up to six messages (paging, Msg1, Msg2, Msg3, Msg4, Msg5); and for MO data, establishing the RRC communication channel may use up to five or more messages (Msg1, Msg2, Msg3, Msg4, Msg5) or more if a buffer status report (BSR) is used, before actual payload data can be transmitted. As used herein, the term enhanced MTC (eMTC) communication refers to improving the efficiency of MTC and IoT communications by having the ability to efficiently communicate between a UE and a base station prior to the establishment of an RRC communication channel between the UE and the base station. Techniques discussed and envisioned herein can aid in reducing overhead used to send MTC/IoT data between (to and from) a UE to a base station.

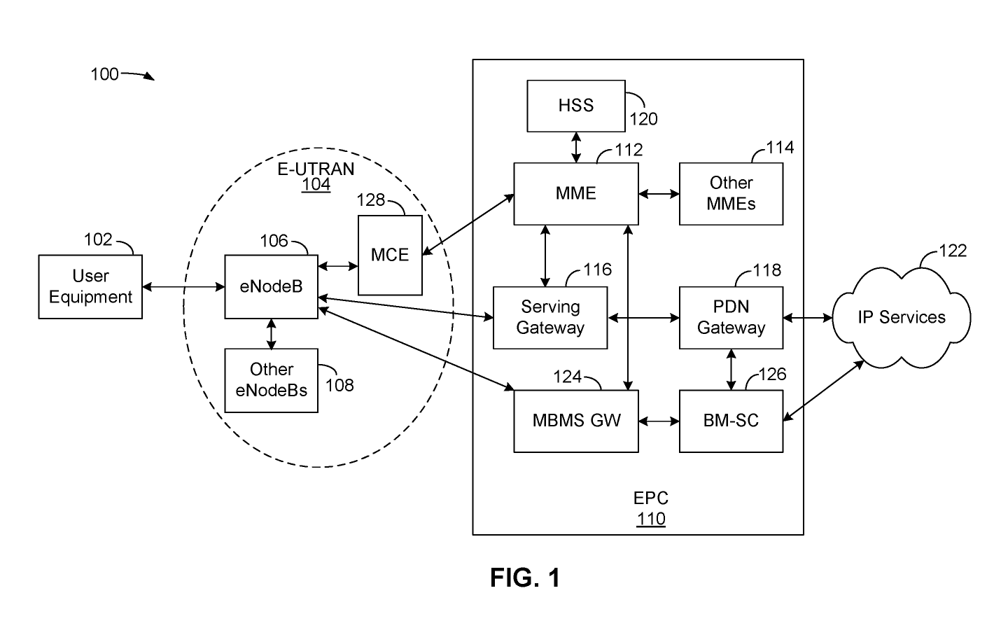

FIG. 1 is a diagram illustrating an LTE cellular communication system architecture 100. The LTE cellular communication system architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services; however, as those skilled in the art will readily appreciate, the various concepts presented throughout this disclosure may be extended to networks providing circuit-switched services. Moreover, while an LTE network is illustrated as an example, other types of networks may also be used, including, for example only, a 5G network.

The E-UTRAN 104 includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, industrial equipment, medical devices, entertainment devices, or many other similar functioning devices capable of wireless transmission. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

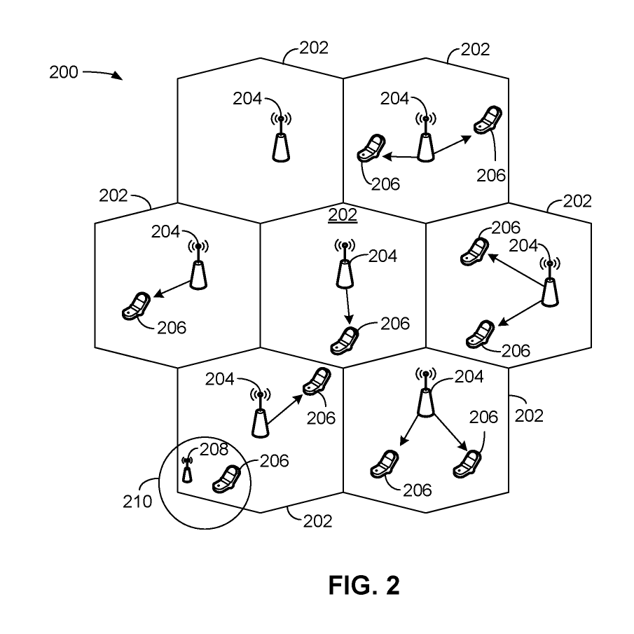

FIG. 2 is a diagram illustrating an example of a cellular network 200 in an LTE network architecture. In this example, the cellular network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO), Ultra Mobile Broadband (UMB), 5G, or other modulation and multiple access techniques. EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-TDMA in the form of a DFT-spread OFDM signal to compensate for high peak-to-average power ratio (PAPR).

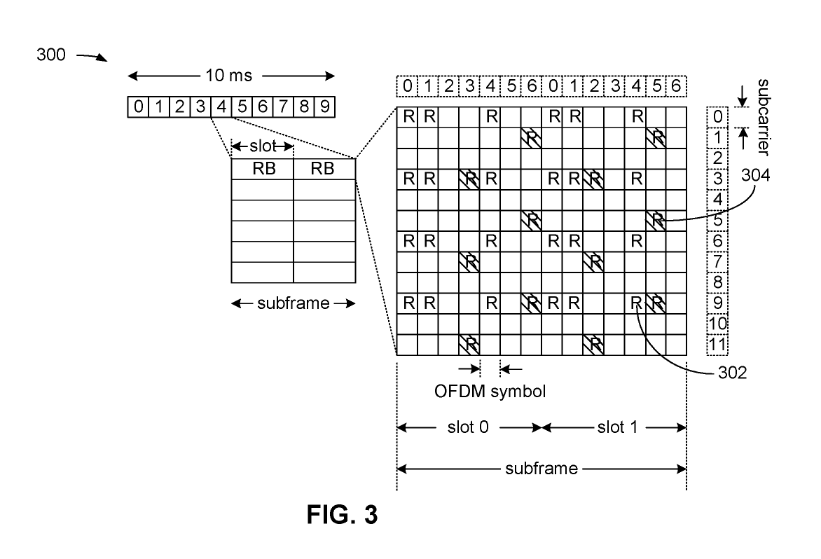

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

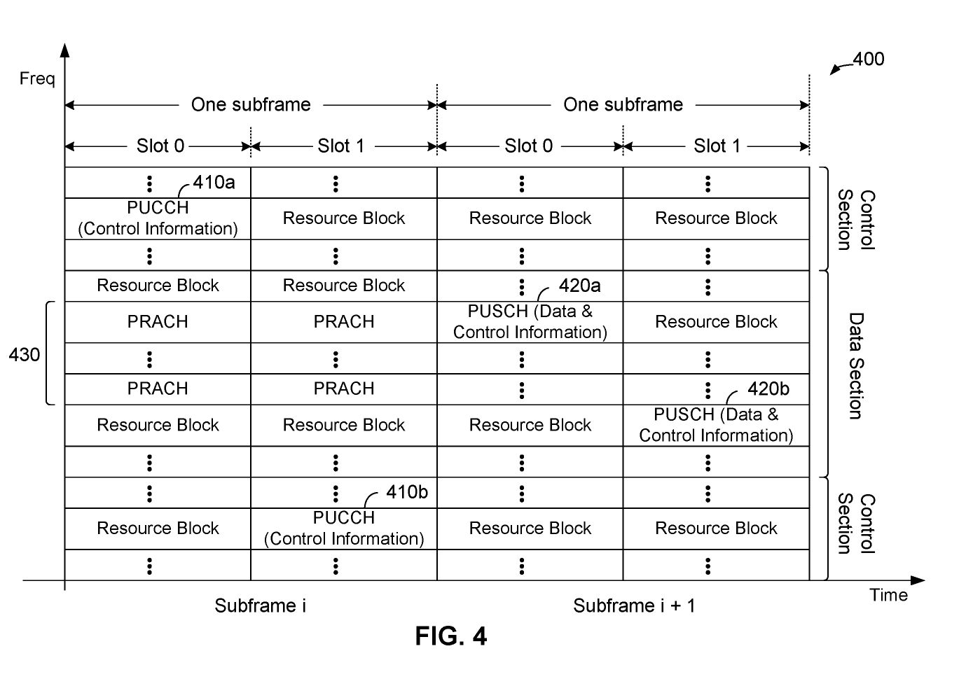

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. The PRACH attempt is carried in a single subframe (1 ms) or in a sequence of few contiguous subframes.

As described herein in accordance with exemplary embodiments of the present disclosure, initial symbols in the PRACH 430, or, if appropriate, a modified PRACH or NPRACH, or initial symbols in the PUSCH 420, or, if appropriate, a modified PUSCH or NPUSCH, can be used by the UE to send small data transmissions for eMTC communications and/or IoT communications prior to the establishment of a radio resource control (RRC) radio communication link between a UE and a base station. As used herein, the term (N)PRACH can be used to refer to a wideband PRACH and/or a narrowband NPRACH and the term (N)PUSCH can be used to refer to a wideband PUSCH and/or a narrowband NPUSCH.

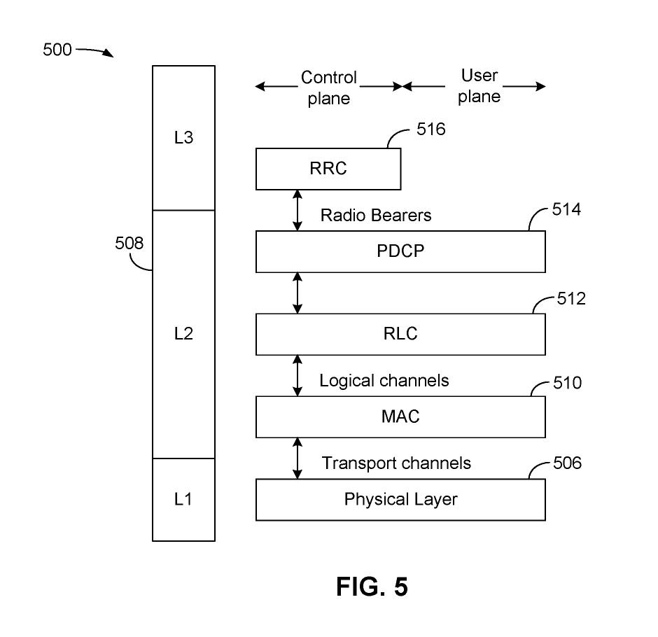

FIG. 5 is a diagram 500 illustrating an example of a radio protocol architecture for the user and control planes in LTE in accordance with various aspects of the present disclosure. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

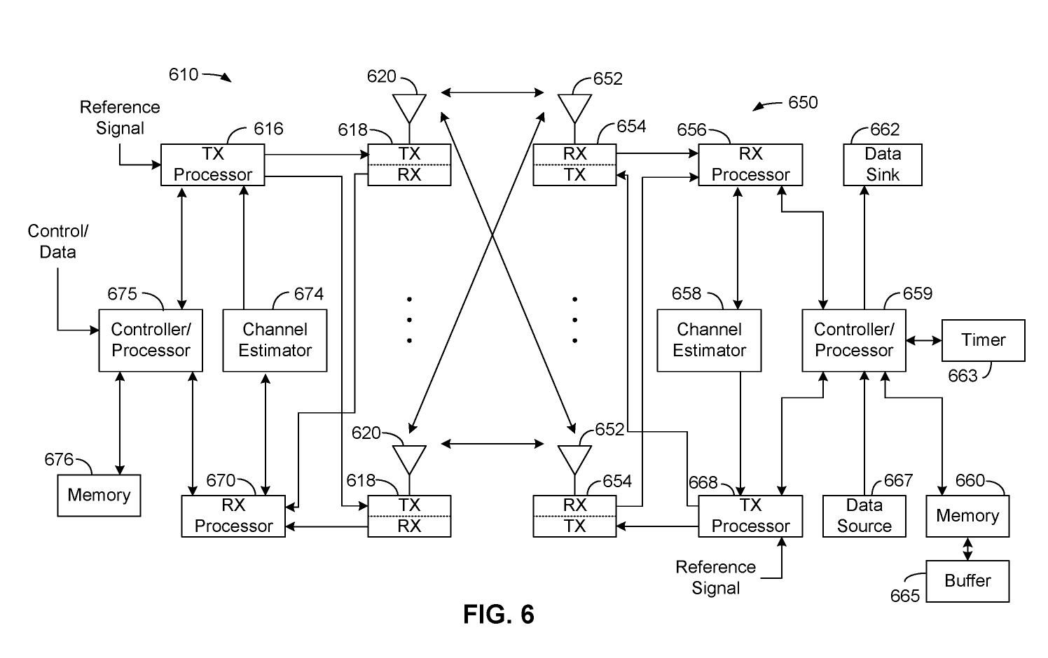

FIG. 6 is a block diagram of an eNB 610 in communication with a UE 650 in an access network in accordance with various aspects of the present disclosure. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

In an exemplary embodiment, the UE 650 may include a timer 663 operatively coupled to the controller/processor 659. In an exemplary embodiment, the timer 663 may be configured as a contention resolution timer 663 that may provide a sequence (SEQ) count and that may be configured to determine communication signal contention when the UE 650 transmits to a base station in Msg1 or in Msg3, as described herein.

In an exemplary embodiment, the UE 650 may include a buffer 665 operatively coupled to the memory 660. In an exemplary embodiment, the buffer 665 may be configured as a Msg3 buffer that may be configured to store Msg3 communications during periods when the UE 650 may be performing contention resolution when transmitting data in Msg1 or Msg3, as described herein.

In an exemplary embodiment, one or both of the eNB 610 and the UE 650 may have logic, software, firmware, configuration files, etc., to allow the MCT/IoT communications described herein.

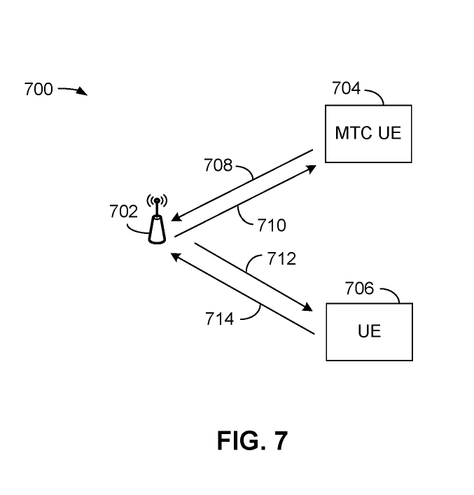

FIG. 7 is a diagram 700 illustrating a communication system in accordance with various aspects of the present disclosure. FIG. 7 includes a node 702, an MTC UE 704, and a UE 706 (also referred to as a “non-MTC UE”). The node 702 can be a macro node (e.g., an eNB), femto node, pico node, or similar base station, a mobile base station, a relay, a UE (e.g., communicating in peer-to-peer or ad-hoc mode with another UE), a portion thereof, and/or substantially any component that communicates control data in a wireless network. The MTC UE 704 and non-MTC UE 706 can each be a mobile terminal, a stationary terminal, a modem (or other tethered device), a portion thereof, and/or substantially any device that receives control data in a wireless network.

As shown in FIG. 7, the MTC UE 704 receives DL transmissions 710 from eNB 702 and sends UL transmissions 708 to the eNB 702. In one aspect, the DL and UL transmissions 710 and 708 may include either MTC control information or MTC data. As further shown in FIG. 7, the UE 706 receives DL transmissions 712 from eNB 702 and sends UL transmissions 714 to the eNB 702.

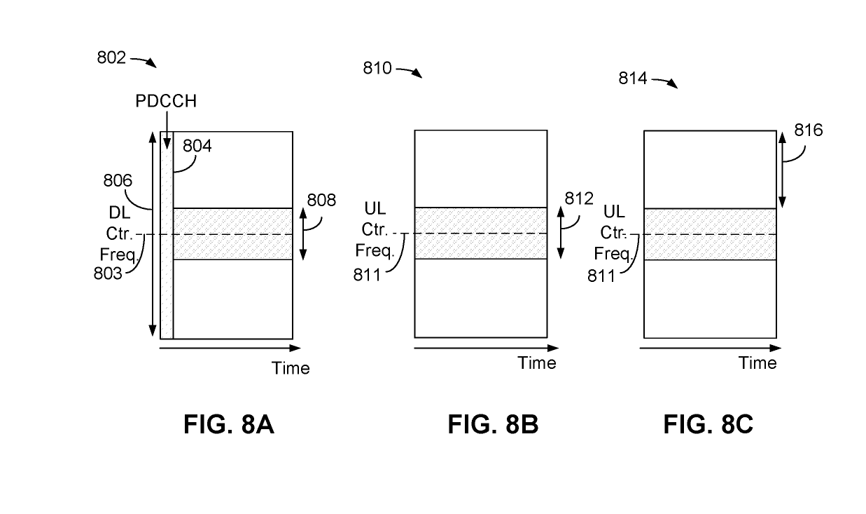

FIGS. 8A through 8C are diagrams 802, 810, and 814 illustrating narrowband operation of MTC UEs in a large bandwidth allocated for non-MTC UEs in accordance with various aspects of the present disclosure. FIG. 8A shows a large bandwidth 806 allocated for non-MTC UEs and further shows a DL center frequency 803. Accordingly, the DL operates in the center of the large bandwidth 806. In the configuration of FIG. 8A, shaded portion 804 is reserved for PDCCH. As further shown in FIG. 8A, narrow bandwidth 808 can be used for both UL and DL and can be used for a primary synchronization signal (PSS), secondary synchronization signal (SSS), physical broadcast channel (PBCH), SIB, and/or paging. For example, the narrow bandwidth can be 1.25 MHz. FIG. 8B shows a UL center frequency 811 and the narrow bandwidth 812. For example, UL random access channel (RACH) messages (e.g., message 1 and message 3) can be communicated by MTC UEs in the UL center frequency 811 to facilitate access to the network. As shown in FIG. 8C, other UL transmissions can be communicated in a bandwidth different from narrow bandwidth 808, such as bandwidth 816. It should be understood that in FIGS. 8A through 8C, the small bandwidth 808 can be located in a region other than the center of the large bandwidth 806.

In a specific example, LTE allows the following transmission modes (TMs): TM1 for single antenna port, TM2 for transmit diversity, TM3 for open loop MIMO, TM4 for close loop MIMO, TM5 for multi-user MIMO, TM6 for single layer closed loop MIMO, TM7 for single layer beamforming with dedicated reference signal (RS), TM8 for dual layer beamforming with dedicated RS, TM9 for MIMO with up to 8 layer transmissions, and TM10 for coordinated multiple point (CoMP). For SIB/MIB transmission, as well as message 2 and message 4 for RACH, the default transmission modes are used: TM1 is used for single and TM2 is used for 2 transmit (Tx) antennas or 4 Tx antennas. The UE can be switched to another transmission mode based on UE specific radio resource control (RRC) signaling.

MIB or physical broadcast channel (PBCH) can contain various information bits, such as bandwidth information bits, physical HARQ indicator channel (PHICH) configuration bits, and SFN bits. The bandwidth information can be four bits; however, such bandwidth information may not be needed for MTC when narrowband operation is used. The PHICH configuration bits can be three bits (e.g., one bit for duration, two bits for PHICH group). However, such PHICH configuration may not be needed if NCT is used or if a fixed control region for PBCH subframe is used. The SFN bits can be eight bits of the most significant bits (MSB) (the other 2 bit from blind decoding of PBCH in 40 ms). The SFN bits can be signaled later in the payload. Antenna information can be conveyed by another signal. PBCH transmission matches around 4 antenna ports, space frequency block code (SFBC) or SFBC-frequency switched transmit diversity (FSTD) is used for antenna numbers of 2 or 4. Combined with 4 timing hypothesis and 3 antenna hypothesis, a total of 12 blind decoding is needed for current PBCH decoding.

Therefore, in order to reduce costs, MTC can be operated in a narrow band, e.g. six resource blocks (RBs). Considering cost saving as well as limited requirement on the data rate, the transmission mode can be restricted only to those without the support of spatial multiplexing.

In an exemplary embodiment, MTC/IoT data may be sent from the UE to the base station using a “connectionless” transmission of UL data (e.g., over non-access stratum (NAS)) in initial messages (e.g. message 1 (Msg1), message 3 (Msg3), or another early message) of a random access procedure, such as a (N)PRACH or (N)PUSCH communication. For transmission in Msg1, the UE may not have uplink timing synchronization, so a waveform that is amenable to contention based communication and unsynchronized transmission may be used. In an exemplary embodiment, a “training sequence” or “communication preamble” may be employed and transmitted in the UL before the actual data payload. In one example, the “training sequence” can be similar to a PRACH or an NPRACH sequence. Alternatively, as the UE may have knowledge of the timing advance (TA) from the UE's last connection with the base station, the UE may utilize the last TA such that the UE's transmissions remain time-synchronized with the base station. This assumes that the UE has not “drifted” since the UE used the TA for its last UL transmission.

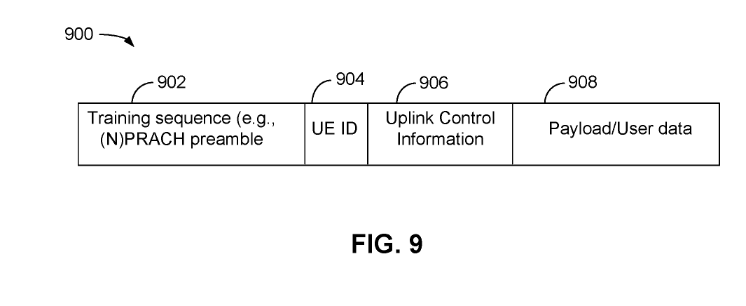

FIG. 9 is a diagram showing an exemplary embodiment of a (N)PRACH communication for use in sending data from a UE that is configured to transmit prior to the establishment of an RRC connection according to embodiments disclosed herein, to a base station using Msg1 in accordance with various aspects of the present disclosure. In an exemplary embodiment, the (N)PRACH communication sequence 900 includes a training sequence field 902, a UE ID field 904, an uplink control information field 906 and a payload data field 908.

For transmission in Msg1, the UE may not have uplink timing synchronization, such that UL transmission is asynchronous. The training sequence 902 may be used and can be transmitted in the uplink (UL) before actual payload data 908 so that the eNB (base station) can estimate the timing of the UL payload from the UE. One example of such a training sequence is the (N)PRACH communication sequence 900.

In accordance with an exemplary embodiment, the (N)PRACH used in LTE may be modified as described herein to include payload (payload data block 908, such as a PUSCH or an (N)PUSCH communication) and this payload may be sent in one, two, three contiguous subframes similar to that in LTE or even in more subframes if needed/defined based on the size of the data packet to be supported. However, it should be noted that the longer the transmission takes to transmit a given payload, the higher the chance of a collision. In the exemplary (N)PRACH communication sequence 900, the UE ID 904 may be implicit from the preamble (i.e., the training sequence 902) and may be absent. Further, the uplink control information 906 (which may indicate the initial MCS, for example) may also be implicit in the training sequence 902, and may be optional as a separate communication, or may be explicitly present, as shown in FIG. 9.

If the uplink control information 906 is absent or does not include UL MCS (modulation and coding scheme), the initial UL MCS also should be predetermined. Alternatively, the UE may be allowed to choose between different initial MCS's based on “history”; however in this case, signaling on the UL to indicate this MCS to the eNB is used. This may be a separate UL control information communication 906. This may be implicitly indicated by partitioning the “training sequences” 902 into multiple communications, including the UL control information.

Initial transmit power may be selected based on channel parameters, or selected based on history. For contention resolution, the UL transmitter should include UE ID (UE identifier) 904 also in Msg1. Examples of such UE ID include IMSI (International Mobile Subscriber Identity) or derived using (IMSI mod x) where x may be defined in the standards, etc.

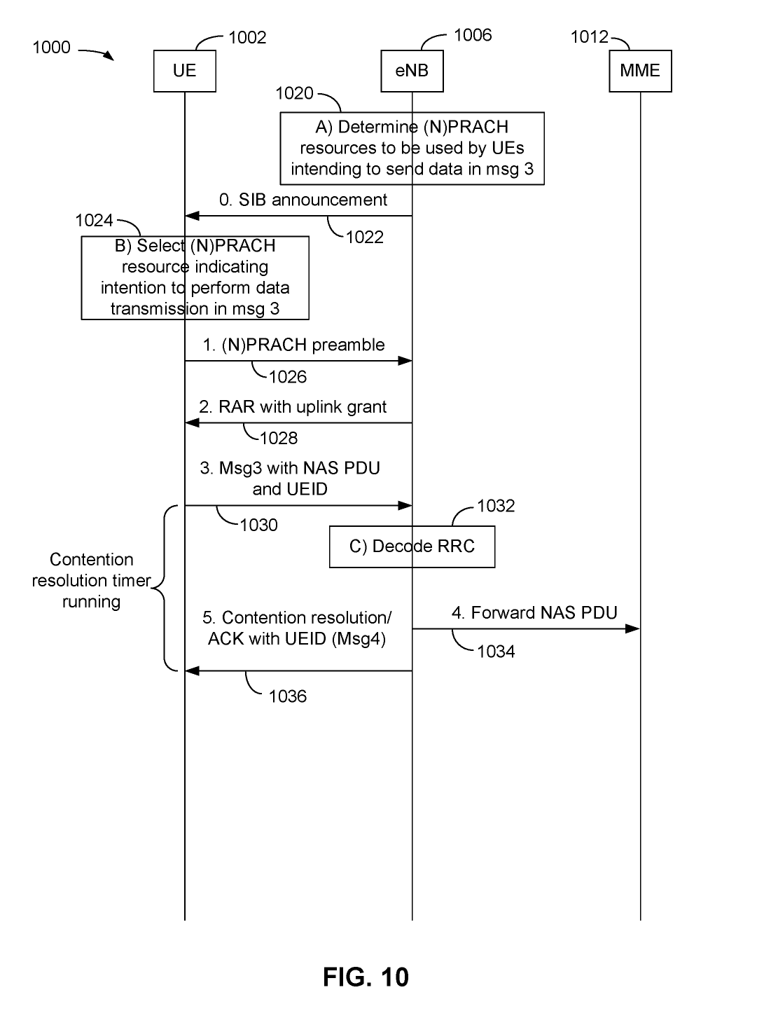

FIG. 10 is a call flow diagram 1000 showing call flow for a UE using Msg3 to send data to a base station, in accordance with various aspects of the present disclosure. The call flow diagram 1000 shows a UE 1002, a base station (eNB) 1006 and an MME 1012. The UE may be an exemplary embodiment of the UE 102 of FIG. 1 or the UE 650 of FIG. 6, the base station (eNB) 1006 may be an exemplary embodiment of the eNB 106 of FIG. 1 or the eNB 610 of FIG. 6, and the MME 1012 may be an exemplary embodiment of the MME 112 of FIG. 1.

In block 1020 (A), a resource determination is made where the base station (eNB) 1006 allows transmission, by the UE 1002, of a packet up to a certain, predefined or configured, size (e.g., up to 10 bytes, up to 20 bytes, etc.) without establishing full RRC connection, as described herein. The size of the packet can vary up to a certain limit and not be just a specific packet size. For example, if the upper limit of the packet size is 10 bytes then any packet size that is <=10 bytes, in this example, can be transmitted. In an exemplary embodiment, the base station (eNB) 1006 allocates (N)PRACH resources for this purpose to be used by a UE intending to perform data transmission in Msg3.

Resources may also be different for different coverage enhancement (CE) levels. A coverage enhancement (CE), a coverage enhancement level (CEL), or an enhanced coverage level (ECL), may refer to a UE's ability to communicate with a network when a UE with a lower CE, CEL, or ECL may not be able to communicate with the same network.

At call 1022 (0.), the eNB 1006 announces the available resources to the UE 1002 via a system information broadcast (SIB) message.

In block 1024 (B), the UE 1002 selects an (N)PRACH resource based on the announced resources and, optionally, the amount of data to transmit and/or the coverage enhancement level. The selection may be based on a random selection, or a deterministic allocation. For random selection, a UE may determine the (N)PRACH resource pool, corresponding to, for example, the amount of data it has to send, and/or the coverage enhancement level, and then randomly select one (N)PRACH resource for its Msg 1 communication prior to the establishment of an RRC connection with the base station (eNB) 1006. For deterministic selection, for example, the UE ID may be used to select an (N)PRACH resource from the pool or to select an (N)PRACH resource that has been explicitly assigned to the UE during prior signaling.

In call 1026 (1.), the UE 1002 transmits the selected (N)PRACH preamble to the base station (eNB) 1006 using the first communication message, Msg1.

In call 1028 (2.), the UE 1002 receives a random access response (RAR) from the base station (eNB) 1006. In current LTE as an example, the RAR may contain an uplink grant, and timing advance (TA) (in addition to a radio network temporary identifier (RNTI). etc.), informing the UE 1002 of the resources available or allocated for uplink (UL) transmission. To enable the transmission of Msg3+data by the UE 1002, the RAR may also include power control information. Alternatively, the UE 1002 may use open-loop power control (i.e., the UE determines transmit power). The RAR received by the UE 1002 in call 1028 defines the amount of resources available to the UE for the transmission of uplink (UL) data.

In call 1030 (3.), if the UE 1002 desires to send data to the base station (eNB) 1006, the UE 1002 transmits the data in a Msg3 communication including the UE ID and a NAS PDU (message 3, plus the UE ID, plus the NAS protocol data unit (data)) using the UL grant indicated in the RAR received from the base station (eNB) 1006 in call 1028. The UE 1002 takes into account the power control information from the RAR, if included. The UE 1002 may start a contention resolution timer after this step. For example, the contention resolution timer may be implemented using the timer 663 and the controller/processor 659 in the exemplary UE 650 of FIG. 6. The call 1030 also includes radio resource control (RRC) information.

In block 1032 (C), the base station (eNB)1006 decodes the radio resource control (RRC) message received from the UE 1002 in call 1030. From this RRC message (Msg3, in this example), the base station 1006 uses part of the information in the Msg3 communication to determine the MME 1012 to which the included user data (the NAS PDU in Msg3, call 1030) will be forwarded.

In call 1034 (4.), the base station (eNB)1006 forwards the NAS PDU, including the uplink data sent by the UE 1002 in call 1030, to the MME 1012. A new S1 message may be defined for this step. The S1 protocol is one used between a base station (eNB) and an MME.

In call 1036 (5.), the base station (eNB)1006 sends the contention resolution message and acknowledgement (ACK) (e.g. using, for example, the MTC physical downlink control channel (MPDCCH) or physical downlink shared channel (PDSCH)) to the UE 1002 with the UE ID in message 4, Msg4. In an exemplary embodiment, the base station (eNB) 1006 may also use the call 1036 (Msg4) to send data to the UE 1002.

It is possible that calls 1034 and 1036 may occur in any order. If contention resolution is not successful, the UE 1002 may return to block 1024.

In LTE, there is a separate Msg3 buffer in the UE 1002 which has a higher priority than an UL buffer for other data/PDUs. In an exemplary embodiment, the Msg3 buffer may exist in or as part of the memory 660, and is shown as the buffer 665, in the UE 650 of FIG. 6.

In an exemplary embodiment, the payload may be included as a common control channel (CCCH) service data unit (SDU) in the UEs Msg3 buffer 665 for transmission. Note that data radio bearer (DRB), packet data convergence protocol (PDCP), or radio link control (RLC) may not have yet been established for this data since this transmission occurs before an RRC connection has been established.

In current LTE specifications, the Msg3 buffer (buffer 665 in FIG. 6) is flushed when a RACH communication fails. For example, the payload data would be lost if the RACH fails due to a Msg3 collision. Therefore, one aspect of the disclosure describes a mechanism to prevent the loss of the payload if Msg3 fails and may include a fallback to the legacy method (for example, attempt to send Msg3+data payload for n number of times, where N is an integer equal to or greater than one, and fallback to the legacy method if the Msg3 communication fails). In an exemplary embodiment, a copy of the data payload may be placed into the Msg3 buffer 665 while maintaining another copy of the data payload in the UE 1002 for potential fallback or retransmission. The buffer 665 in the UE may be located in the memory 660, the controller/processor 659, or may be another dedicated buffer in the UE 650 of FIG. 6 for example. In one aspect, an RLC AM (radio link control-acknowledged mode) like protocol may be defined for this data transmission at the NAS layer.

In an exemplary embodiment, the minimum size of the Msg3 UL grant may be defined as 56 bits for legacy (LTE), and 88 bits for NB-IoT. There is no restriction on the base station (eNB) granting larger resource grants to the UE, with a tradeoff based on the likelihood of a collision in the Msg3 communication. The tradeoff may be more important where a large number of repetitions are involved because the resource (a large block of resources) is blocked for multiple transmission time intervals (TTIs). The base station (eNB) may be able to use a statistical model to estimate the probability of collision of preambles by knowing the total number of preambles, and the expected number of “active” UEs (arrival) based on the traffic pattern.

The base station (eNB) may use the estimated collision probability to decide between providing larger grants for “Msg3+data” vs smaller grant for legacy (LTE) Msg3. The UE may differentiate between grants for Msg3+data vs grants for legacy (LTE) Msg3 by the size of the grant implicitly (for example, if grant >threshold, then it is for Msg3+data), or by using an explicit flag in the grant. The UE may determine how to use this grant (e.g., for RRC message only or for RRC message and data in the Msg3 communication).

The NAS PDU, extracted from Msg3, may be forwarded from the base station (eNB) 1006 to the MME 1012 (in call 1034) over an S1 communication link. The S1 communication link may be established after the RRC connection is completed. However, in the exemplary embodiment shown in FIG. 10, there is no RRC communication established when the call 1034 is performed. In accordance with an exemplary embodiment, further security measures may be implemented to prevent a “fake” base station (eNB) from collecting the UL data from the UE 1002. While the data can be encrypted and integrity protected, a “fake” base station (eNB) may cause service denial to a genuine UE, e.g., by accepting the data, confirming to the UE the data has been received and discarding it. To overcome such a denial of service, it may be beneficial for the MME 1012 to provide an acknowledgement, such as an MME ACK, which the base station 1006 may forward along with contention resolution to the UE 1002. The MME ACK is security protected, hence the UE 1002 will be able to verify whether the NAS PDU was delivered to the genuine MME 1012.

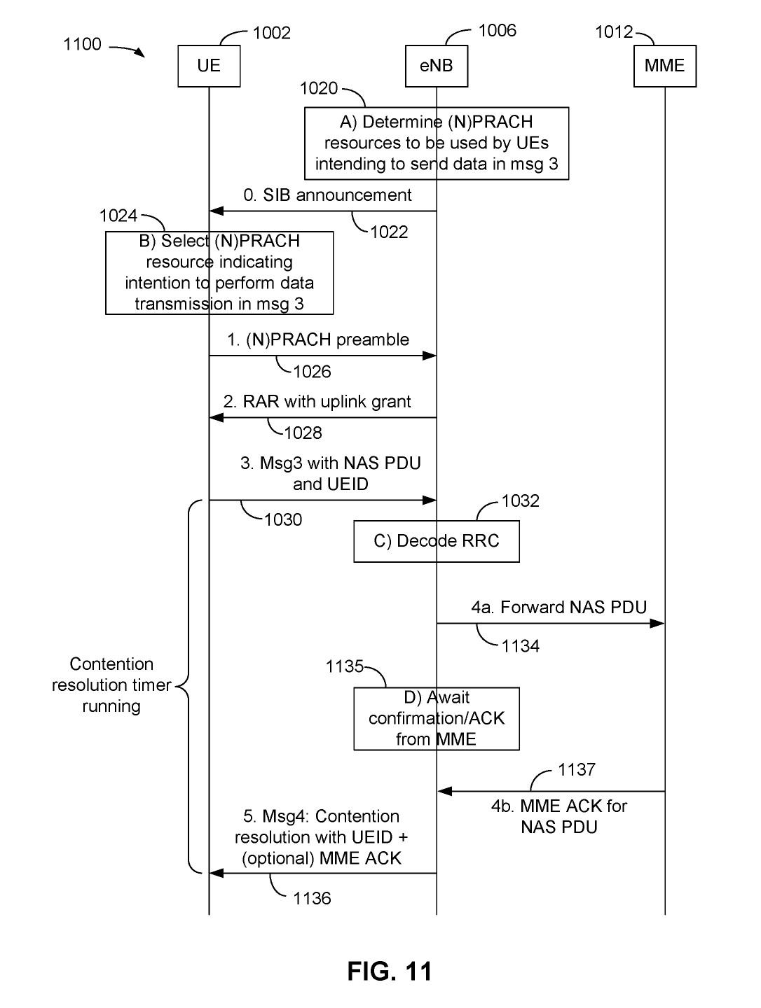

FIG. 11 is a call flow diagram showing call flow for a UE using Msg3 to send data to a base station including an exemplary embodiment of enhanced acknowledgement, in accordance with various aspects of the present disclosure. The blocks and calls in FIG. 11 up to and including block 1032 are similar to the identically numbered blocks and calls in FIG. 10.

In block 1020 (A), a resource determination is made where the base station (eNB) 1006 allows transmission, by the UE 1002, of a packet up to a certain size (e.g., up to 10 bytes, up to 20 bytes, etc., as described above) without establishing a full RRC connection. In an exemplary embodiment, the base station (eNB) 1006 allocates (N)PRACH resources for this purpose to be used by a UE intending to perform data transmission in Msg3. Resources may also be different for different coverage enhancement (CE) levels.

At call 1022 (0.), the base station (eNB) 1006 announces the available resources to the UE 1002 via a system information broadcast (SIB) message.

In block 1024 (B), the UE 1002 selects an (N)PRACH resource based on the announced resources and, optionally, the amount of data to transmit and/or the coverage enhancement level. The (N)PRACH resource selection may be based on a random selection, or a deterministic allocation, as described above.

In call 1026 (1.), the UE 1002 transmits the selected (N)PRACH preamble to the base station (eNB) 1006 using the first communication message, Msg1.

In call 1028 (2.), the UE 1002 receives a random access response (RAR) from the base station (eNB) 1006.

In call 1030 (3.), if the UE 1002 desires to send data to the base station (eNB) 1006, the UE 1002 transmits the data in a Msg3 communication including the UE ID and a NAS PDU (message 3, plus the UE ID, plus the NAS protocol data unit (data)) using the UL grant indicated in the RAR received from the base station (eNB) 1006 in call 1028. The UE 1002 takes into account the power control information from the RAR, if included. The UE 1002 may start a contention resolution timer after this step. For example, the contention resolution timer may be implemented using the timer 663 and the controller/processor 659 in the exemplary UE 650 of FIG. 6.

In block 1032 (C), the base station (eNB)1006 decodes the radio resource control (RRC) message received from the UE 1002 in call 1030.

In call 1134 (4a.), the base station (eNB) 1006 forwards the NAS PDU to the MME 1012. A new S1 message may be defined for this step. The S1 protocol is one used between a base station (eNB) and an MME. This is the same as call 1034 in FIG. 10.

In block 1135 (D), the base station (eNB) 1006 awaits confirmation/ACK from the MME 1012.

In call 1137 (4b.), the MME 1012 sends an ACK to the base station (eNB) 1006 for the NAS PDU sent in call 1134. In one example, the MME 1012 may also indicate in the ACK message in call 1137 whether or not any downlink (DL) data is expected for the UE 1002.

In call 1136 (5.), the base station (eNB) 1006 sends the contention resolution message and optional ACK (using, for example, physical downlink control channel (MPDCCH or NPDCCH) or physical downlink shared channel ((N)PDSCH)) to the UE 1002 with the UE ID in message 4, Msg4. The call 1136 may explicitly include an MME-ACK or may implicitly serve as MME-ACK and confirm to the UE 1002 that the data successfully reached the MME 1012. There may be a delay associated with waiting (block 1135, step D), so in the exemplary embodiment shown in FIG. 11, the contention resolution timer may be longer at the UE 1002 than the contention resolution timer described in FIG. 10. Because of the delay associated with waiting for confirmation (block 1135, step D), in the exemplary embodiment shown in FIG. 11, the base station (eNB) 1006 may determine, at least based on the contention resolution timer value for the UE 1002, that call 1136 (step 5) should be performed without waiting for call 1137 (step 4b) to complete, in order to avoid the expiry of the contention resolution timer 663 at the UE.

Msg4 (1036 in FIGS. 10 and 1136 in FIG. 11) may also serve as confirmation that the data was successfully sent in the uplink, thereby alleviating the need of a higher-layer (e.g. application layer) ACK, such as a transmission control protocol (TCP)-ACK from the TCP server. This can be beneficial to reduce the communication load in the downlink.

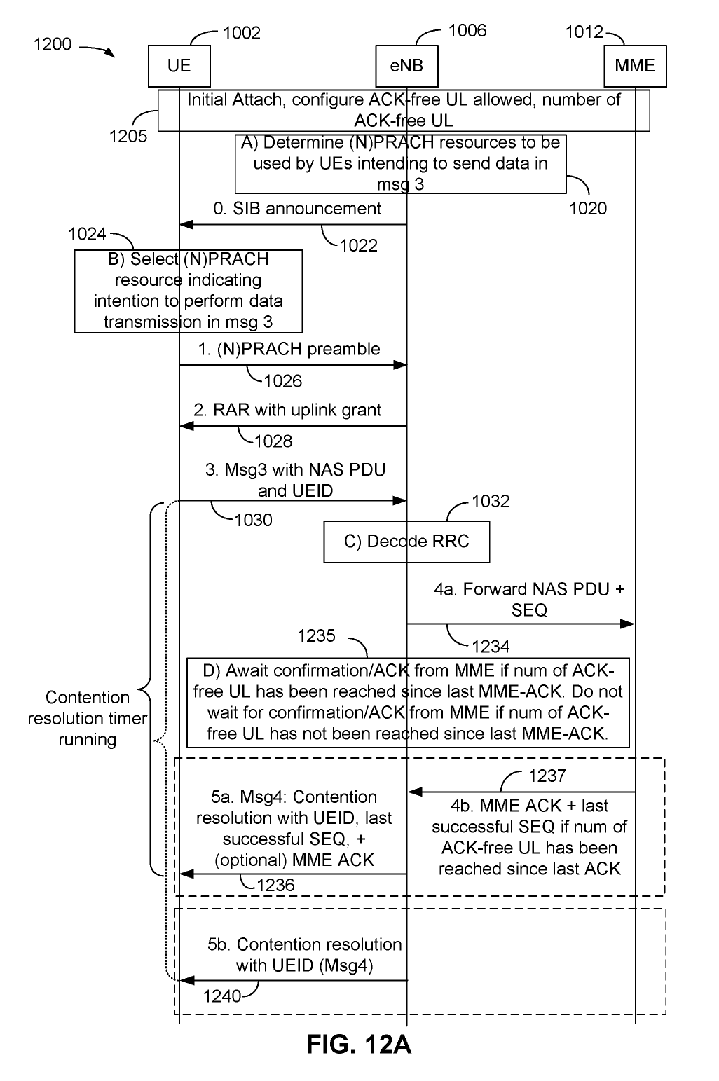

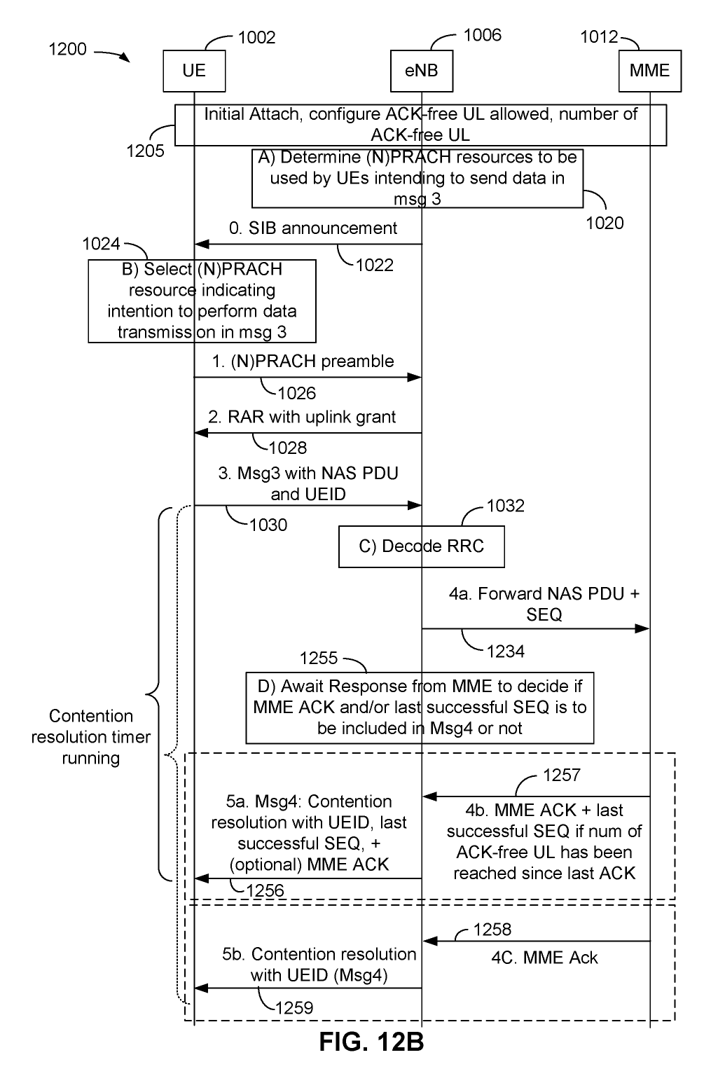

FIG. 12A is a call flow diagram showing call flow for a UE using Msg3 to send data to a base station including an exemplary embodiment of enhanced security, in accordance with various aspects of the present disclosure. The blocks and calls in FIG. 12A are similar to the blocks and calls in FIG. 10 and FIG. 11 up to block 1032.

In an exemplary embodiment, a difference between FIG. 12A and FIG. 11 is that in FIG. 12A the base station (eNB) 1006 does not always wait for the ACK from the MME 1012 (referred to as ACK-free), but does so sufficiently often so that a security breach may be detectable.

In block 1205, an initial attachment of the UE 1002 to the serving base station (eNB) 1006 occurs with the base station (eNB) 1006 configuring the UE 1002 for ACK-free uplink and configuring the UE 1002 for the number of ACK-free packets allowed. The UE 1002 may be configured with a new configuration allowing/disallowing an ACK-free uplink (UL). The UE 1002 may also be configured with how often it should expect MME-ACK (number of ACK-free packets) from the base station (eNB) 1006.

In block 1020 (A), a resource determination is made where the base station (eNB) 1006 allows transmission, by the UE 1002, of a packet up to a certain size (e.g., up to 10 bytes, up to 20 bytes, etc., as described above) without establishing a full RRC connection. In an exemplary embodiment, the base station (eNB) 1006 allocates (N)PRACH resources for this purpose to be used by a UE intending to perform data transmission in Msg3. Resources may also be different for different coverage enhancement (CE) levels.

At call 1022 (0.), the base station (eNB) 1006 announces the available resources to the UE 1002 via a system information broadcast (SIB) message.

In block 1024 (B), the UE 1002 selects an (N)PRACH resource based on the announced resources and, optionally, the amount of data to transmit and/or the coverage enhancement level. The selection may be based on a random selection, or a deterministic allocation, as described above.

In call 1026 (1.), the UE 1002 transmits the selected (N)PRACH preamble to the base station (eNB) 1006 using the first communication message, Msg1.

In call 1028 (2.), the UE 1002 receives a random access response (RAR) from the base station (eNB) 1006.

In call 1030 (3.), if the UE 1002 desires to send data to the base station (eNB) 1006, the UE 1002 transmits the data in a Msg3 communication including the UE ID and a NAS PDU (message 3, plus the UE ID, plus the NAS protocol data unit (data)) using the UL grant indicated in the RAR received from the base station (eNB) 1006 in call 1028. The UE 1002 takes into account the power control information from the RAR, if included. The UE 1002 may start a contention resolution timer after this step. For example, the contention resolution timer may be implemented using the timer 663 and the controller/processor 659 in the exemplary UE 650 of FIG. 6.

In block 1032 (C), the base station (eNB) 1006 decodes the radio resource control (RRC) message received from the UE 1002 in call 1030.

In call 1234 (4a.), the base station (eNB) 1006 includes a sequence (SEQ) count in the NAS PDU communication to the MME 1012. The SEQ count is implemented in the UE 1002 and is incremented for each new NAS PDU sent by the UE 1002. The MME 1012 keeps track of the SEQ count and knows if any packets are missing. For example, a SEQ counter may be implemented using the counter 663 and the controller/processor 659 in the exemplary UE 650 of FIG. 6, and its value may be reported to the MME 1012.

In block 1235 (D), the base station (eNB) 1006 awaits confirmation/ACK from the MME 1012 if the predetermined number of ACK-free packets has been reached since the last MME-ACK. The base station (eNB) 1006 does not await a confirmation/ACK from the MME 1012 if the predetermined number of ACK-free packets has not been received since the last MME-ACK.

In a first of two possible courses of action, in call 1237 (4b.), if the predetermined number of ACK-free packets has been reached since the last MME-ACK, the MME 1012 sends an ACK along with the last successful SEQ count if the number of ACK-free packets has been reached since the last MME-ACK. The last successful SEQ count can be used by the base station (eNB) 1006 to identify any irregularity in the communication or can be forwarded to the UE 1002 by the base station (eNB) 1006, which can be used by the UE 1002 to identify any communication irregularity or to determine whether retransmission is needed. In one example, the MME 1012 may also indicate in the ACK message whether or not any downlink (DL) data is expected for the UE 1002.

In call 1236 (5a.), the base station (eNB) 1006 sends the contention resolution/ACK message (using, for example, physical downlink control channel (MPDCCH/NPDCCH) or physical downlink shared channel (PDSCH/NPDSCH)) with the UE ID and the last successful SEQ count in message 4, Msg4. The call 1236 may explicitly include an MME-ACK or may implicitly serve as MME-ACK and confirm to the UE 1002 that the data successfully reached MME 1012, at which time the contention resolution timer 663 ends after call 1236 as shown by the solid line representation of the contention resolution timer 663 in this embodiment. The call 1237 (4b.) may not be present for all sessions. The base station (eNB) 1006 is aware of when to expect MME-ACK from the MME 1012 (based on the initial negotiation of ACK-free UL), so it may proceed to call 1240 for the session with no MME-ACK. Further, the contention resolution timer for the session with ACK-free packets and packets requiring ACK may be different (due to additional S1 roundtrip time for the packets requiring MME-ACK) Because of the delay associated with waiting for the ACK from the MME (block 1235, step D), in the exemplary embodiment shown in FIG. 12A, the base station (eNB) 1006 may determine, at least based on the contention resolution timer value for the UE 1002, that call 1240 (step 5b) should be performed without waiting for call 1237 (step 4b) to complete, in order to avoid the expiry of the contention resolution timer 663 at the UE, as shown by the dotted line representation of the contention resolution timer 663 ending after call 1240 in this embodiment.

In an optional course of action if block 1237 is not performed or the base station (eNB) 1006 decides not to wait for block 1237 to complete as described above, in call 1240 (5b) (instead of call 1236), the base station (eNB) 1006 sends the contention resolution message (using, for example, the physical downlink control channel (MPDCCH/NPDCCH) or physical downlink shared channel (PDSCH/NPDSCH)) with the UE ID in message 4, Msg4. The call 1240 may explicitly include an MME-ACK or may implicitly serve as MME-ACK and confirm to the UE 1002 that the data successfully reached MME 1012.

FIG. 12B is a call flow diagram showing call flow for a UE using Msg3 to send data to a base station including an exemplary embodiment of enhanced security, in accordance with various aspects of the present disclosure. The blocks and calls in FIG. 12B are similar to the blocks and calls in FIG. 10 and FIG. 11 up to block 1032.

In an exemplary embodiment, a difference between FIG. 12B and FIG. 11 is that in FIG. 12B the base station (eNB) 1006 waits for a response from the MME 1012 to decide if an MME ACK is to be included in the Msg4 communication to the UE 1002.

In block 1205, an initial attachment of the UE 1002 to the serving base station (eNB) 1006 occurs with the base station (eNB) 1006 configuring the UE 1002 for ACK-free uplink and configuring the UE 1002 for the number of ACK-free packets allowed. The UE 1002 may be configured with a new configuration allowing/disallowing an ACK-free uplink (UL). The UE 1002 may also be configured with how often it should expect MME-ACK (number of ACK-free packets) from the base station (eNB) 1006.

In block 1020 (A), a resource determination is made where the base station (eNB) 1006 allows transmission, by the UE 1002, of a packet up to a certain size (e.g., up to 10 bytes, up to 20 bytes, etc., as described above) without establishing a full RRC connection. In an exemplary embodiment, the base station (eNB) 1006 allocates (N)PRACH resources for this purpose to be used by a UE intending to perform data transmission in Msg3. Resources may also be different for different coverage enhancement (CE) levels.

At call 1022 (0.), the base station (eNB) 1006 announces the available resources to the UE 1002 via a system information broadcast (SIB) message.

In block 1024 (B), the UE 1002 selects an (N)PRACH resource based on the announced resources and, optionally, the amount of data to transmit and/or the coverage enhancement level. The selection may be based on a random selection, or a deterministic allocation, as described above.

In call 1026 (1.), the UE 1002 transmits the selected (N)PRACH preamble to the base station (eNB) 1006 using the first communication message, Msg1.

In call 1028 (2.), the UE 1002 receives a random access response (RAR) from the base station (eNB) 1006.

In call 1030 (3.), if the UE 1002 desires to send data to the base station (eNB) 1006, the UE 1002 transmits the data in a Msg3 communication including the UE ID and a NAS PDU (message 3, plus the UE ID, plus the NAS protocol data unit (data)) using the UL grant indicated in the RAR received from the base station (eNB) 1006 in call 1028. The UE 1002 takes into account the power control information from the RAR, if included. The UE 1002 may start a contention resolution timer after this step. For example, the contention resolution timer may be implemented using the timer 663 and the controller/processor 659 in the exemplary UE 650 of FIG. 6.

In block 1032 (C), the base station (eNB) 1006 decodes the radio resource control (RRC) message received from the UE 1002 in call 1030.

In call 1234 (4a.), the base station (eNB) 1006 includes a sequence (SEQ) count in the NAS PDU communication to the MME 1012. The SEQ count is implemented in the UE 1002 and is incremented for each new NAS PDU sent by the UE 1002. The MME 1012 keeps track of the SEQ count and knows if any packets are missing. For example, the SEQ counter may be implemented using the counter 663 and the controller/processor 659 in the exemplary UE 650 of FIG. 6.

In block 1255 (D), the base station (eNB) 1006 waits for a response from the MME 1012 to decide if an MME ACK and/or a last successful SEQ count is to be included in the Msg4 communication to the UE 1002.

In call 1257 (4b.), in a first of two possible courses of action, the MME 1012 sends an ACK along with the last successful SEQ count if the number of ACK-free packets has been reached since the last MME-ACK. The last successful SEQ count can be used by the base station (eNB) 1006 to identify any communication irregularity or can be forwarded to the UE 1002 by the base station (eNB) 1006, which can be used by the UE 1002 to identify a communication irregularity or to determine whether retransmission is needed.

In call 1256 (5a.), the base station (eNB) 1006 sends the contention resolution/ACK message (using, for example, physical downlink control channel (MPDCCH/NPDCCH) or physical downlink shared channel (PDSCH/NPDSCH)) with the UE ID and the last successful SEQ count in message 4, Msg4. The call 1256 may explicitly include an MME-ACK or may implicitly serve as MME-ACK and confirm to the UE 1002 that the data successfully reached MME 1012, as shown by the solid line representation of the contention resolution timer 663 ending after call 1236 in this embodiment. The call 1257 (4b.) may not be present for all sessions. The base station (eNB) 1006 is aware of when to expect MME-ACK from the MME 1012 (based on the initial negotiation of ACK-free UL), so it may proceed to call 1259 (5b) for the session with no MME-ACK. Further, the contention resolution timer for the session with ACK-free packets and packets requiring ACK may be different (due to additional S1 roundtrip time for the packets requiring MME-ACK). Because of the delay associated with waiting for MME ACK (block 1255, step D), in an exemplary embodiment shown in FIG. 12B, the base station (eNB) 1006 may determine, at least based on the contention resolution timer value for the UE 1002, that call 1259 (step 5b) should be performed without waiting for call 1257 (step 4b) to complete, in order to avoid the expiry of the contention resolution timer 663 at the UE, which in this embodiment is shown using a dotted line representation of the contention resolution timer 663 ending after call 1259 in this embodiment.

In call 1258, as an optional course of action if call 1257 is not performed, the MME 1012 sends an ACK to the base station (eNB) 1006 without including the last successful SEQ count. If call 1257 is not performed or the base station (eNB) 1006 decides not to wait for call 1257 to complete as described above, in call 1259 (instead of call 1256), the base station (eNB) 1006 sends the contention resolution message (using, for example, physical downlink control channel (MPDCCH/NPDCCH) or physical downlink shared channel (PDSCH/NPDSCH)) with the UE ID in message 4, Msg4. The call 1259 may explicitly include an MME-ACK or may implicitly serve as MME-ACK and confirm to the UE 1002 that the data successfully reached MME 1012.

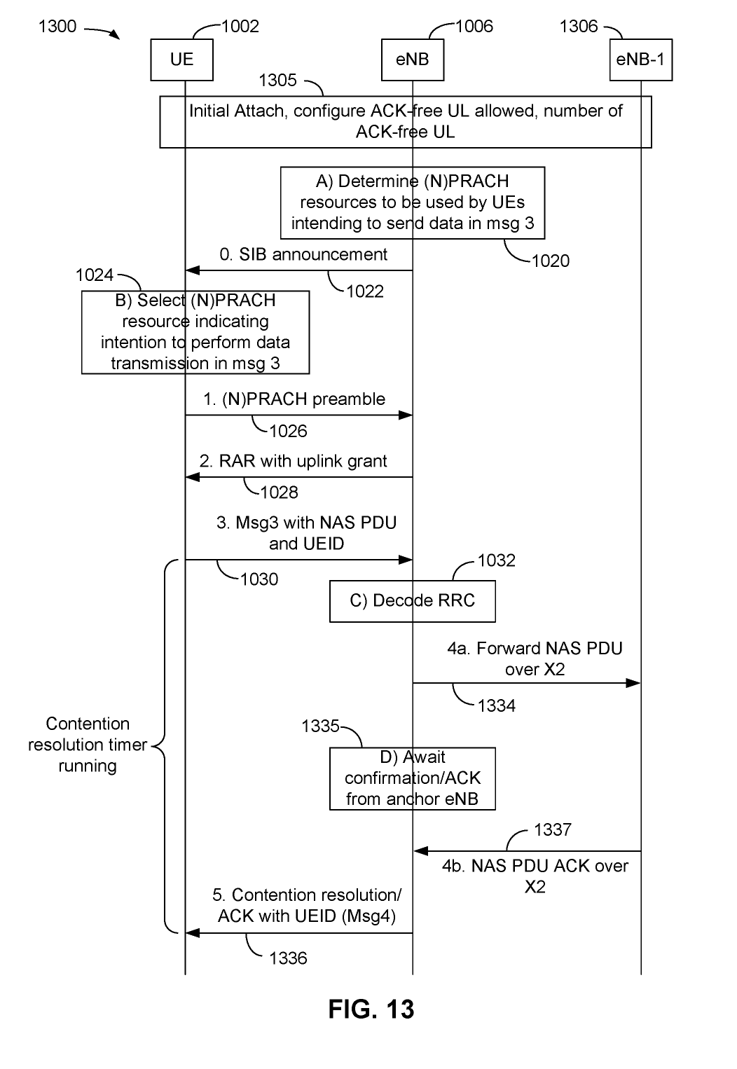

FIG. 13 is a call flow diagram showing call flow for a UE using Msg3 to send data to a base station including an exemplary embodiment of enhanced security, in accordance with various aspects of the present disclosure. The blocks and calls in FIG. 13 are similar to the blocks and calls in FIG. 10 and FIG. 11.

In this exemplary embodiment, the UE 1002 communicates with the base station (eNB) 1006, which, in this exemplary embodiment, is referred to as a serving base station (eNB). The serving base station (eNB) 1006 communicates with what is referred to as an anchor base station (eNB-1) 1306. The anchor base station (eNB-1) 1306 may maintain the UE context and confirm the NAS packet reception from the serving base station (eNB) 1006 and forward to a serving gateway (S-GW) (not shown).

In block 1305, an initial attachment of the UE 1002 to the serving base station (eNB) 1006 occurs with the base station (eNB) 1006 configuring the UE 1002 for ACK-free uplink and configuring the UE 1002 for the number of ACK-free packets allowed.

The anchor base station (eNB-1) 1306 stores the UE 1002 context including the radio access network (RAN) security context of the UE 1002.

In block 1020 (A), a resource determination is made where the base station (eNB) 1006 allows transmission, by UE 1002, of a packet up to certain size (e.g., up to 10 bytes, up to 20 bytes, etc., as described above) without establishing full RRC connection. In an exemplary embodiment, the base station (eNB) 1006 allocates (N)PRACH resources for this purpose to be used by a UE intending to perform data transmission in Msg3. Resources may also be different for different coverage enhancement (CE) levels.

At call 1022 (0.), the base station (eNB) 1006 announces the available (N)PRACH resources to the UE 1002 via a system information broadcast (SIB) message.

In block 1024 (B), the UE 1002 selects an (N)PRACH resource based on the announced (N)PRACH resources and, optionally, the amount of data to transmit and/or the coverage enhancement level. The selection may be based on a random selection, or a deterministic allocation, as described above.

In call 1026 (1.), the UE 1002 transmits the selected (N)PRACH preamble to the base station (eNB) 1006 using the first communication message, Msg1.

In call 1028 (2.), the UE 1002 receives a random access response (RAR) from the base station (eNB) 1006.

In call 1030 (3.), if the UE 1002 desires to send data to the base station (eNB) 1006, the UE 1002 transmits the data in a Msg3 communication including the UE ID and a NAS PDU (message 3, plus the UE ID, plus the NAS protocol data unit (data)) using the UL grant indicated in the RAR received from the base station (eNB) 1006 in call 1028. The UE 1002 takes into account the power control information from the RAR, if included. The UE 1002 may start a contention resolution timer after this step. For example, the contention resolution timer may be implemented using the timer 663 and the controller/processor 659 in the exemplary UE 650 of FIG. 6.

In block 1032 (C), the base station (eNB)1006 decodes the radio resource control (RRC) message received from the UE 1002 in call 1030.

In call 1334 (4a.), the serving base station (eNB) 1006 forwards the NAS PDU to the anchor base station (eNB-1) 1306 over an X2 link, which is faster than the S1 link used to communicate with an MME.

In block 1335 (D), the serving base station (eNB) 1006 awaits confirmation/ACK from the anchor base station (eNB-1) 1306.

In call 1337 (4b.), the anchor base station (eNB-1) 1306 sends an ACK to the serving base station (eNB) 1006 for the NAS PDU communication sent in call 1334 over the X2 network connection. In one example, the anchor eNB-1 1306 may also indicate in the ACK message whether or not any DL data is expected for the UE 1002.

In call 1336 (5.), the serving base station (eNB) 1006 sends the contention resolution message and ACK (e.g. using, for example, the MTC physical downlink control channel (MPDCCH/NPDCCH) or physical downlink shared channel (PDSCH, NPDSCH)) to the UE 1002 with the UE ID in message 4, Msg4. The call 1336 serves as NAS PDU-ACK and confirms to the UE 1002 that the data successfully reached the anchor base station (eNB-1) 1306. There may be a delay associated with waiting (block 1335, step D), which may be long, so the contention resolution timer in FIG. 13 may be longer at the UE 1002 than the contention timer in FIG. 10. Because of the delay associated with waiting (block 1335, step D), in the exemplary embodiment shown in FIG. 13, the base station (eNB) 1006 may determine, at least based on the contention resolution timer value for the UE 1002, that call 1336 (step 5) should be performed without waiting for call 1337 (step 4b) to complete, in order to avoid the expiry of the contention resolution timer 663 at the UE.

An advantage is that handling such context of many UEs may be infeasible for a regular serving base station (eNB) 1006, but may be possible for the anchor base station (eNB-1) 1306. The round trip delay of the communication over the X2 link may be much shorter than the round trip delay of communication over the S1 link. In some deployments, the serving base station (eNB) 1006 and the anchor base station (eNB-1) 1306 may be located at the same node or may be co-located.

The UE 1002 uses an ID which is already known to the anchor base station (eNB-1) 1306 (e.g. resume ID) to identify itself to the anchor base station (eNB-1) 1036. The serving base station (eNB) 1006 forwards the data to the anchor base station (eNB-1) 1306 based on this UE ID. The MME/S-GW/P-GW (PDN Gateway), etc., are not shown in FIG. 13.

The base station (eNB) may differentiate between the UEs supporting the early data transmission in accordance with different embodiments of this disclosure and the legacy UEs which may not be capable of the early data transmissions.

In an exemplary embodiment, the base station (eNB) 1006 may partition the (N)PRACH resources such that it can implicitly infer the capabilities of the UE. For example, if the UE uses (N)PRACH from the pool of the available resources allocated for early data transmission, the base station (eNB) 1006 knows that the UE 1002 is capable of the early data transmissions.

In another exemplary embodiment, the UE 1002 may indicate this capability by including additional capability indication information elements during the initial attach procedure using capability indication methods. For this exemplary embodiment of the disclosure, new capability bits to indicate the new capabilities may be defined.

In some cases, a base station (eNB) may be able to detect Msg1 collisions (this is also applicable for legacy (LTE) systems). Note that the term “collision” in this description means more than one UE sending the same preamble on the same (N)PRACH resource (same sub carrier(s) at the same time). Two UEs sending different preambles do not result in collision in this context. If a UE does not receive an UL grant (e.g., because of collision, interference, etc.) it will retry (N)PRACH again after a random back off period.

The above description is based on shared (N)PRACH resources for a group of UEs using early UL transmission mechanisms as described. Given that the expected data arrival may be infrequent, it may be possible for the base station (eNB) to provide “contention-free” (N)PRACH to each UE. The (N)PRACH resources may be allocated as contention-free resources based on a pre-configured pattern. An example of a pre-configured pattern may be that a UE is informed, or configured, in advance what resources to use for PRACH. The term “advance” means during the previous active state (while the UE is in active state it is told what PRACH resources to use the next time it want to transition from idle to connected/active state). As used herein, the term “contention-free” refers to resources that other UEs should not be allowed to use. This means that the network (i.e., the base station (eNB) 1006 in particular) should not include these resources in the pool of resources that can be selected by any other UE and that the network should not allocate these resources to another UE at the same time. Contention-free means that there is one and only one UE that can use these resources at any one time.

A predefined timing, periodicity or pattern may be defined for each UE to have access to a dedicated (N)PRACH preamble at a particular (time, frequency) resource.

The predefined resource may be present during a predefined time window to increase the probability for the UE of successful acquisition and usage of such resource.

For this case, the contention resolution (step 5, 5a, or 5b in FIGS. 10, 11, 12A, 12B, and 13) may be omitted. In such scenarios, a separate ACK indication (e.g., 1-bit) using a separate control channel may be introduced instead of a contention resolution MAC PDU in shared data channel.

In an exemplary embodiment, the network has at least a partial knowledge of UEs' traffic patterns. The UE may provide this information to the network at the time of initial attachment. Alternatively, the base station (eNB) or other network node may use estimation methods to estimate the traffic pattern of the UE based on the history of the data transmissions from the UE.

Alternatively, for example, the UE may indicate how long before its next expected transmission and the network may indicate the future dedicated (N)PRACH resource (or its index) in step 5, 5a or 5b, of the current session.

In another alternative embodiment, the base station (eNB) may allocate a predefined “time window” within which the UE performs a contention based (N)PRACH. This can be beneficial when a large number of UEs are present in the network and the network wants to “smooth” out the possible peaks of access requests by distributing the UEs across different time windows.

The base station (eNB) reserves a set of resources for the data transfer in Msg3. A partition of Msg1 resources according to different CE levels and/or coverage levels is possible.

Acknowledgement/contention resolution may be transmitted in control channel or data channel (e.g. using RA-RNTI (random access RNTI)), including the UE ID of the UE communication that made it through, and may also include additional information such as SEQ as described above.

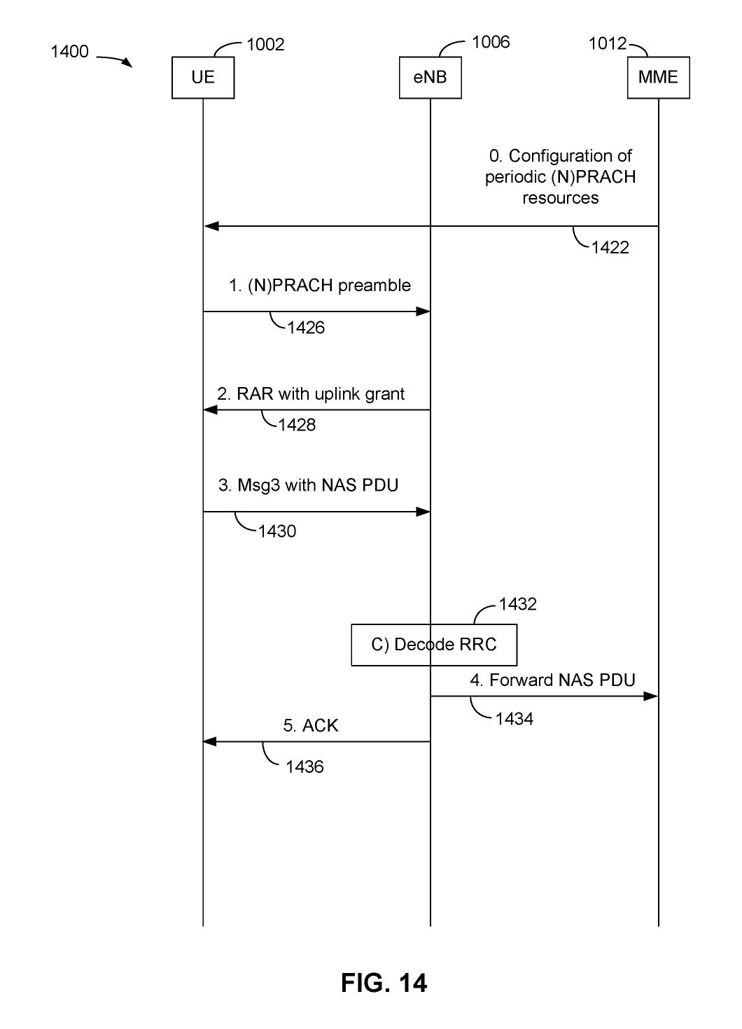

FIG. 14 is a call flow diagram 1400 showing call flow for a UE using Msg3 to send data to a base station, in accordance with various aspects of the present disclosure. The call flow diagram 1400 describes an exemplary semi-persistent scheduling (SPS) embodiment where a UE may receive periodically scheduled resources with which to transmit a small data communication to a base station using Msg3.

The call flow diagram 1400 shows a UE 1002, a base station (eNB) 1006 and an MME 1012. The UE may be an exemplary embodiment of the UE 102 of FIG. 1 or the UE 650 of FIG. 6, the base station (eNB) 1006 may be an exemplary embodiment of the eNB 106 of FIG. 1 or the eNB 610 of FIG. 6, and the MME 1012 may be an exemplary embodiment of the MME 112 of FIG. 1.

At call 1422 (0.), the MME 1012 configures periodic (N)PRACH resources for the UE 1002. For example, the MME 1012 may configure a reserved (N)PRACH resource for the UE 1002 twice per day (or another period), with the resources identified using, for example, hyper frame number (HFN)/system frame number (SFN). The resources configured in call 1422 are considered to be contention free. In addition, other UEs should not be allowed to use these resources. This means that the network (i.e., the base station (eNB) 1006 in particular) should not include this resource in the pool of resources that can be selected by any other UE and that the network should not allocate these resources to another UE at the same time. As used herein, the term “contention-free”means that there is one and only one UE that can use these resources at any one time. The (N)PRACH resources may be allocated as contention-free resources based on a pre-configured pattern, as described above.

In call 1426 (1.), the UE 1002 transmits the selected (N)PRACH preamble to the base station (eNB) 1006 using the first communication message, Msg1.

In call 1428 (2.), the UE 1002 receives a random access response (RAR) from the base station (eNB) 1006. In current LTE as an example, the RAR may contain an uplink grant, and timing advance (TA) (in addition to a radio network temporary identifier (RNTI). etc.), informing the UE 1002 of the resources available or allocated for uplink (UL) transmission. To enable the transmission of Msg3+data by the UE 1002, the RAR may also include power control information. Alternatively, the UE 1002 may use open-loop power control (i.e., the UE decides on transmit power). The RAR received by the UE 1002 in call 1428 defines the amount of resources available to the UE for the transmission of uplink (UL) data.

In call 1430 (3.), if the UE 1002 desires to send data to the base station (eNB) 1006, the UE 1002 transmits Msg3 with UE ID and NAS PDU (message 3, plus the UE ID, plus the NAS protocol data unit (data)) using the UL grant indicated in the RAR received from the base station (eNB) 1006 in call 1428. The UE 1002 takes into account the power control information from the RAR, if included.

In block 1432 (C), the base station (eNB) 1006 decodes the radio resource control (RRC) message received from the UE 1002 in call 1430.

In call 1434 (4.), the base station (eNB) 1006 forwards the NAS PDU to the MME 1012. A new S1 message may be defined for this step. The S1 link is one used between a base station (eNB) and an MME.

In call 1436, the UE 1002 receives an acknowledgement (ACK) from the base station 1006.

In the exemplary embodiment shown in FIG. 14, the transmission of Msg1 (in call 1426), occurs in a reserved (N)PRACH resource, such that the resources are likely to be contention-free and the likelihood of Msg1 collision is avoided. The transmission of data in Msg3 (call) 1430) occurs in an (N)PUSCH communication.

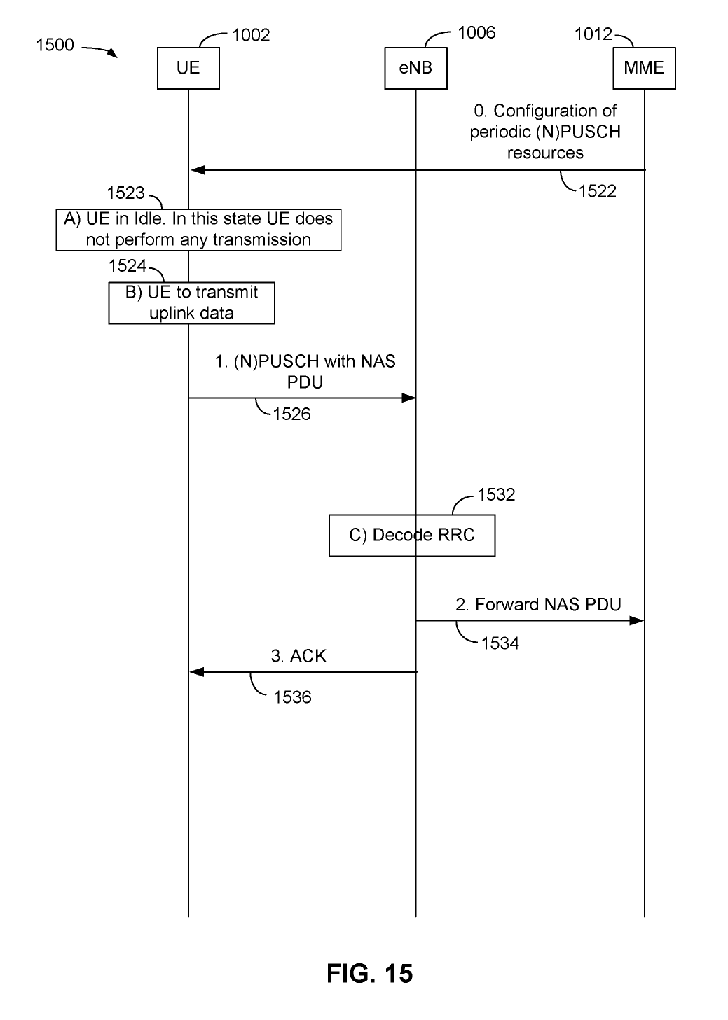

FIG. 15 is a call flow diagram 1500 showing call flow for a UE using a first communication message to send data to a base station, in accordance with various aspects of the present disclosure. The call flow diagram 1500 describes an exemplary semi-persistent scheduling (SPS) embodiment where a UE may send user payload data in an (N)PUSCH communication directly.

The call flow diagram 1500 shows a UE 1002, a base station (eNB) 1006 and an MME 1012. The UE may be an exemplary embodiment of the UE 102 of FIG. 1 or the UE 650 of FIG. 6, the base station (eNB) 1006 may be an exemplary embodiment of the eNB 106 of FIG. 1 or the eNB 610 of FIG. 6, and the MME 1012 may be an exemplary embodiment of the MME 112 of FIG. 1.

At call 1522 (0.), the MME 1012 configures periodic (N)PUSCH resources for the UE 1002. For example, the MME 1012 may configure a reserved (N)PUSCH resource for the UE 1002 twice per day (or another period), with the resources identified using, for example, hyper frame number (HFN)/system frame number (SFN).

In an exemplary embodiment, in semi-persistent scheduling (SPS), the UE 1002 skips transmission of Msg1 and reception of Msg2 and directly transmits data in Msg3 as the UE's “first communication” to the base station (eNB) 1006. This occurs because Msg1 is used by the UE 1002 to request uplink resources to send user data and Msg2 carries the allocation from the base station (eNB) to the UE to assign the resources the UE can use to send Msg3. In an exemplary embodiment in which SPS is used, the UE 1002 was previously allocated resources (both time and frequency) for Msg3, and hence the UE does not send Msg1 and receive Msg 2, and can directly transmit data using Msg3 as its first communication to a base station.

In block 1523 the UE 1002 is in idle mode for a period of time.

In block 1524, the UE 1002 determines that it has data to transmit.

In call 1526 (1.), if the UE 1002 desires to send data to the base station (eNB) 1006, the UE 1002 transmits the (N)PUSCH communication including the NAS PDU, which in this exemplary embodiment may be referred to as Msg1, immediately as the first message when the UE that is in idle mode desires to transmit data to the network. In an exemplary embodiment, this first communication may also include an (N)PRACH communication, i.e., the communication sequence 900 of FIG. 9.

In block 1532 (C), the base station (eNB)1006 decodes the radio resource control (RRC) message received from the UE 1002 in call 1526.

In call 1534 (4.), the base station (eNB)1006 forwards the NAS PDU to the MME 1012. A new S1 message may be defined for this step. The S1 link is one used between a base station (eNB) and an MME.

In the exemplary embodiment shown in FIG. 15, the transmission of the NAS PDU (in call 1526), occurs in a reserved (N)PUSCH resource, and is sent directly by the UE 1002 when it is in idle mode (block 1523) and has data to transmit to the base station (eNB) 1006. In this exemplary embodiment, the state in which the UE decides to transmit data to the network in idle mode may be referred to as “RRC-Idle-Transmit” mode to differentiate it from “RRC Idle” mode where UE is in an idle mode where it is not transmitting or waiting for response to a transmission.

In call 1536, the UE 1002 receives an acknowledgement (ACK) from the base station 1006.

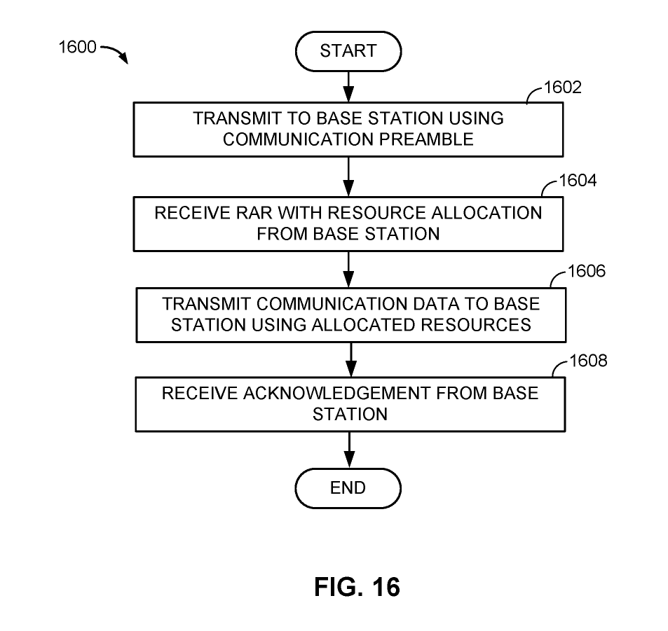

FIG. 16 is a flow chart illustrating an example of a method for communication, in accordance with various aspects of the present disclosure. The blocks in the method 1600 can be performed in or out of the order shown, and in some embodiments, can be performed at least in part in parallel.

In block 1602, the UE 1002 transmits the (N)PRACH preamble to the base station (eNB) 1006 using the first communication message, Msg1, in the preamble.

In block 1604, the UE 1002 receives a random access response (RAR) from the base station (eNB) 1006. In current LTE as an example, the RAR may contain an uplink grant, and timing advance (TA) (in addition to a radio network temporary identifier (RNTI). etc.), informing the UE 1002 of the resources available for uplink (UL) transmission.

In block 1606, if the UE 1002 desires to send data to the base station (eNB) 1006, the UE 1002 transmits Msg3 with UE ID along with NAS PDU (message 3, plus the UE ID, plus the NAS protocol data unit (data)) using the allocated resources identified in the UL grant indicated in the RAR received from the base station (eNB) 1006.

In block 1608, the UE 1002 receives acknowledgement from the base station (eNB) 1006, confirming successful reception of Msg3 by the base station (eNB) 1006.

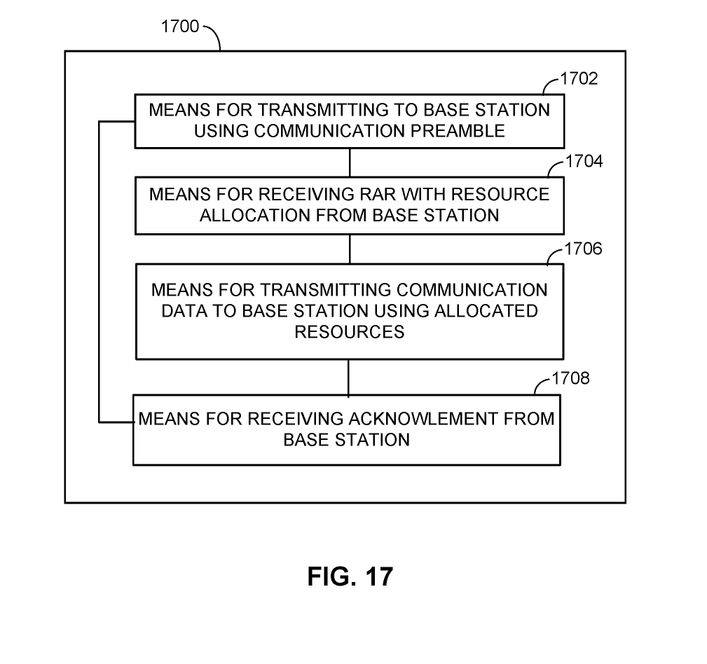

FIG. 17 is a functional block diagram of an apparatus for communication in accordance with various aspects of the present disclosure.

The apparatus 1700 comprises means 1702 for the UE 1002 transmitting the (N)PRACH preamble to the base station (eNB) 1006 using the first communication message, Msg1, in the preamble. In certain embodiments, the means 1702 for the UE 1002 transmitting the (N)PRACH preamble to the base station (eNB) 1006 using the first communication message, Msg1, in the preamble can be configured to perform one or more of the functions described in operation block 1602 of method 1600 (FIG. 16). In an exemplary embodiment, the means 1702 for the UE 1002 transmitting the (N)PRACH preamble to the base station (eNB) 1006 using the first communication message, Msg1, in the preamble may comprise the UE 1002 transmitting in message 1 to the base station (eNB) 1006, of FIGS. 10, 11, 12A, 12B, 13, 14 and 15, and various embodiments thereof.

The apparatus 1700 further comprises means 1704 for the UE 1002 receiving a random access response (RAR) from the base station (eNB) 1006. In certain embodiments, the means 1704 for the UE 1002 receiving a random access response (RAR) from the base station (eNB) 1006 can be configured to perform one or more of the functions described in operation block 1604 of method 1600 (FIG. 16). In an exemplary embodiment, the means 1704 for the UE 1002 receiving a random access response (RAR) from the base station (eNB) 1006 may comprise the UE 1002 receiving a RAR message that may contain an uplink grant, and timing advance (TA) (in addition to a radio network temporary identifier (RNTI). etc.), informing the UE 1002 of the resources available for uplink (UL) transmission.

The apparatus 1700 further comprises means 1706 for the UE 1002 transmitting Msg3 with UE ID and NAS PDU (message 3, plus the UE ID, plus the NAS protocol data unit (data)) to the base station (eNB) 1006 using the allocated resources identified in the UL grant indicated in the RAR received from the base station (eNB) 1006.

In certain embodiments, the means 1706 for the UE 1002 transmitting Msg3 with UE ID and NAS PDU (message 3, plus the UE ID, plus the NAS protocol data unit (data)) to the base station (eNB) 1006 using the allocated resources identified in the UL grant indicated in the RAR received from the base station (eNB) 1006 can be configured to perform one or more of the functions described in operation block 1606 of method 1600 (FIG. 16). In an exemplary embodiment, the means 1706 for the UE 1002 transmitting Msg3 with UE ID and NAS PDU (message 3, plus the UE ID, plus the NAS protocol data unit (data)) to the base station (eNB) 1006 using the allocated resources identified in the UL grant indicated in the RAR received from the base station (eNB) 1006 may comprise the UE 1002 sending data to the base station (eNB) 1006 using message 3 (Msg3) in the communication preamble of a random access procedure.

The apparatus 1700 further comprises means 1708 for the UE 1002 receiving an acknowledgement from the base station 1006. In certain embodiments, the means 1708 for the UE 1002 receiving an acknowledgement from the base station 1006 can be configured to perform one or more of the functions described in operation block 1608 of method 1600 (FIG. 16). In an exemplary embodiment, the means 1708 for the UE 1002 receiving an acknowledgement from the base station 1006 may comprise the UE 1002 receiving an acknowledgement from the base station (eNB) 1006.

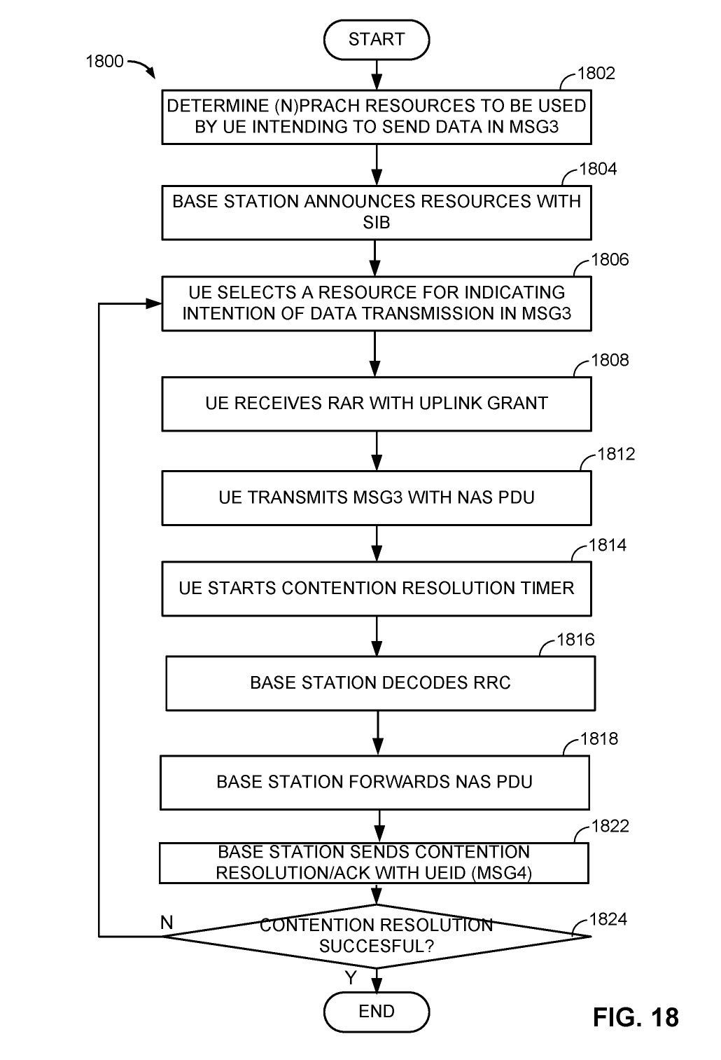

FIG. 18 is a flow chart illustrating an example of a method for communication, in accordance with various aspects of the present disclosure. The blocks in the method 1800 can be performed in or out of the order shown, and in some embodiments, can be performed at least in part in parallel.

In block 1802, a resource determination is made where the base station (eNB) 1006 allows transmission of packets up to certain size (e.g., up to 10 bytes, up to 20 bytes, etc., as described above) without establishing full RRC connection. In an exemplary embodiment, the base station (eNB) 1006 allocates (N)PRACH resources for this purpose. Resources may also be different for different coverage enhancement (CE) levels.

In block 1804, a base station announces the available resources to a UE via a system information broadcast (SIB) message. In an exemplary embodiment, the base station (eNB) 1006 announces the available resources to the UE 1002 via a system information broadcast (SIB) message.

In block 1806, a UE selects a resource for data transmission. In an exemplary embodiment, the UE 1002 selects an (N)PRACH resource based on the announced resources and, optionally, the amount of data to transmit. The selection may be based on a random selection, or a deterministic allocation, as described above. The UE 1002 transmits the selected (N)PRACH preamble to the base station (eNB) 1006 using the first communication message, Msg1.

In block 1808, a UE receives a random access response (RAR) including a grant of uplink resources from a base station. In an exemplary embodiment, the UE 1002 receives a random access response (RAR) from the base station (eNB) 1006. In current LTE as an example, the RAR may contain an uplink grant, and timing advance (TA) (in addition to a radio network temporary identifier (RNTI). etc.), informing the UE 1002 of the resources available or allocated for uplink (UL) transmission. To enable the transmission of Msg3+data by the UE 1002, the RAR may also include power control information. Alternatively, the UE 1002 may use open-loop power control (i.e., the UE decides on transmit power). The RAR received by the UE 1002 in block 1808 defines the amount of resources available to the UE for the transmission of uplink (UL) data.

In block 1812, a UE transmits data to a base station. For example, if the UE 1002 desires to send data to the base station (eNB) 1006, the UE 1002 transmits Msg3 with the UE ID and the NAS PDU (message 3, plus the UE ID, plus the NAS protocol data unit (data)) using the UL grant indicated in the RAR received from the base station (eNB) 1006 in block 1808.

In block 1814, a UE may start a contention resolution timer. For example, the contention resolution timer may be implemented using the timer 663 and the controller/processor 659 in the exemplary UE 650 of FIG. 6.

In block 1816, a base station may attempt to decode an RRC message. For example, the eNB1006 may decode the radio resource control (RRC) message received from the UE 1002.

In block 1818, a base station may forward the NAS PDU to the MME. For example, the eNB1006 forwards the NAS PDU to the MME 1012. A new S1 message may be defined for this step. The S1 protocol is one used between a base station (eNB) and an MME.

In block 1822, a base station sends a contention resolution message/acknowledgement (ACK) to a UE with the UE ID in Msg4. For example, the base station (eNB) 1006 sends the contention resolution message (e.g. using, for example, the MTC physical downlink control channel (MPDCCH) or physical downlink shared channel (PDSCH)) to the UE 1002 with the UE ID in message 4, Msg4.

In block 1824, it is determined whether the contention resolution was successful. If the contention resolution was successful, the process ends. If the contention resolution was not successful, the process returns to block 1806.

It is possible that blocks 1818 and 1822 may occur in any order.

In LTE, there is a separate Msg3 buffer in the UE 1002 which has a higher priority than the UL buffer. In an exemplary embodiment, the Msg3 buffer may comprise the buffer 665 and may exist in or as part of the memory 660 in the UE 650 of FIG. 6.

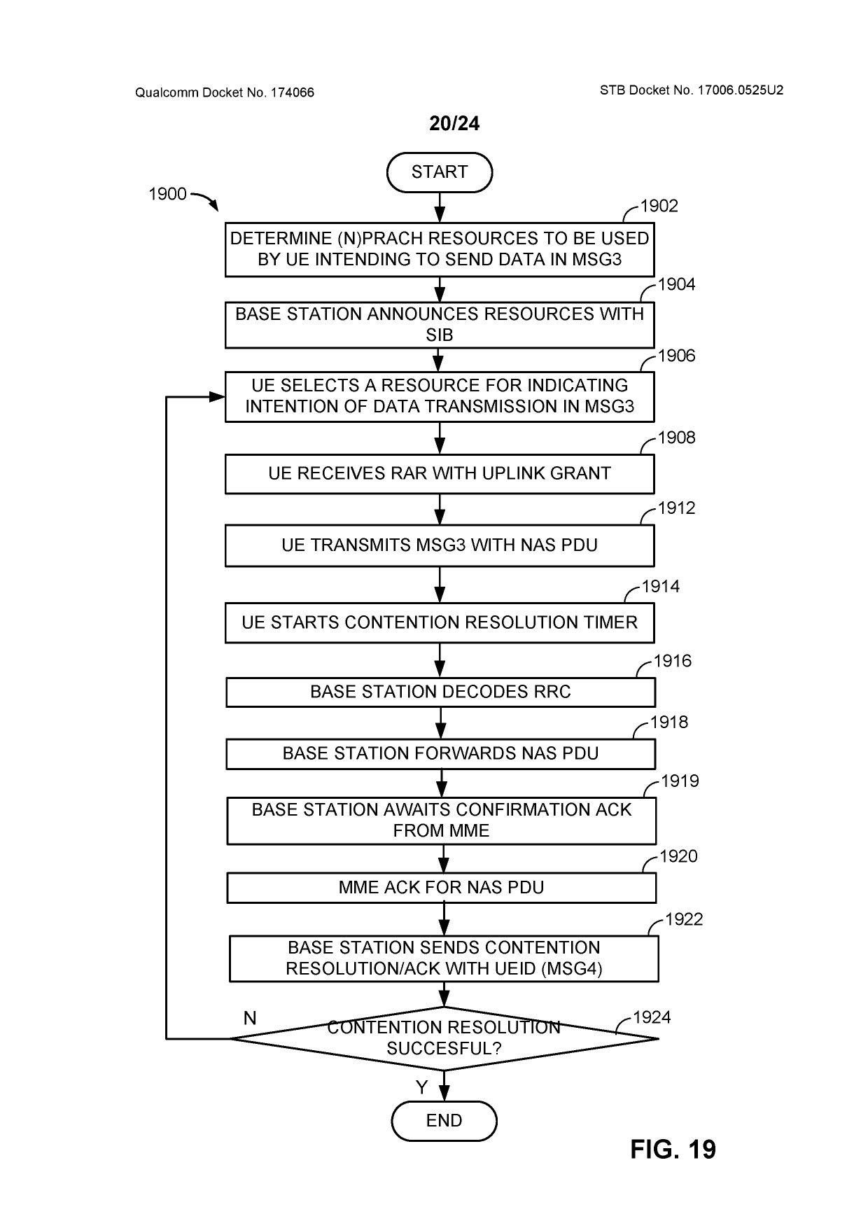

FIG. 19 is a flow chart illustrating an example of a method for communication, in accordance with various aspects of the present disclosure. The blocks in the method 1900 can be performed in or out of the order shown, and in some embodiments, can be performed at least in part in parallel. The blocks 1902 through 1916 in FIG. 19 are similar to the blocks 1802 through 1816 in FIG. 18.

In block 1902, a resource determination is made where the base station (eNB) 1006 allows transmission of packets up to certain size (e.g., up to 10 bytes, up to 20 bytes, etc., as described above) without establishing full RRC connection. In an exemplary embodiment, the base station (eNB) 1006 allocates (N)PRACH resources for this purpose. Resources may also be different for different coverage enhancement (CE) levels.

In block 1904, a base station announces the available resources to a UE via a system information broadcast (SIB) message. In an exemplary embodiment, the base station (eNB) 1006 announces the available resources to the UE 1002 via a system information broadcast (SIB) message.

In block 1906, a UE selects a resource for data transmission. In an exemplary embodiment, the UE 1002 selects an (N)PRACH resource based on the announced resources and, optionally, the amount of data to transmit. The selection may be based on a random selection, or a deterministic allocation, as described above. The UE 1002 transmits the selected (N)PRACH preamble to the base station (eNB) 1006 using the first communication message, Msg1.

In block 1908, a UE receives a random access response (RAR) including a grant of uplink resources from a base station. In an exemplary embodiment, the UE 1002 receives a random access response (RAR) from the base station (eNB) 1006, as described herein.

In block 1912, a UE transmits data to a base station. For example, if the UE 1002 desires to send data to the base station (eNB) 1006, the UE 1002 transmits Msg3 with UE ID and NAS PDU (message 3, plus the UE ID, plus the NAS protocol data unit (data)) using the UL grant indicated in the RAR received from the base station (eNB) 1006 in block 1908.

In block 1914, a UE may start a contention resolution timer. For example, the contention resolution timer may be implemented using the timer 663 and the controller/processor 659 in the exemplary UE 650 of FIG. 6.

In block 1916, a base station may attempt to decode an RRC message. For example, the base station (eNB) 1006 may decode the radio resource control (RRC) message received from the UE 1002.

In block 1918, a base station may forward the NAS PDU to the MME. For example, the eNB1006 forwards the NAS PDU to the MME 1012. A new 51 message may be defined for this step. The S1 protocol is one used between a base station (eNB) and an MME.

In block 1919, a base station awaits a confirmation acknowledgement (ACK) from an MME. For example, the base station (eNB) 1006 awaits confirmation/ACK from the MME 1012.

In block 1920, the MME 1012 sends an ACK to the base station (eNB) 1006 for the NAS PDU sent in block 1918.

In block 1922, the base station (eNB) 1006 sends the contention resolution message (e.g. using, for example, the MTC physical downlink control channel (MPDCCH/NPDCCH) or physical downlink shared channel (PDSCH/NDSCH)) to the UE 1002 with the UE ID in message 4, Msg4. The message in block 1922 serves as MME-ACK and confirms to the UE 1002 that the data successfully reached the MME 1012. There may be a delay associated with waiting (block 1919), which may be long, so, in the exemplary embodiment shown in FIG. 19, the contention resolution timer may be longer at the UE 1002 than the contention resolution timer described in FIG. 18. Msg4 (1036 in FIGS. 10 and 1136 in FIG. 11) may also serve as confirmation that the data was successfully sent in the uplink, thereby alleviating the need of a higher-layer (e.g. application layer) ACK, such as a transmission control protocol (TCP)-ACK from the TCP server. This can be beneficial to reduce the communication load in the downlink.

In block 1924, it is determined whether the contention resolution was successful. If the contention resolution was successful, the process ends. If the contention resolution was not successful, the process returns to block 1906.

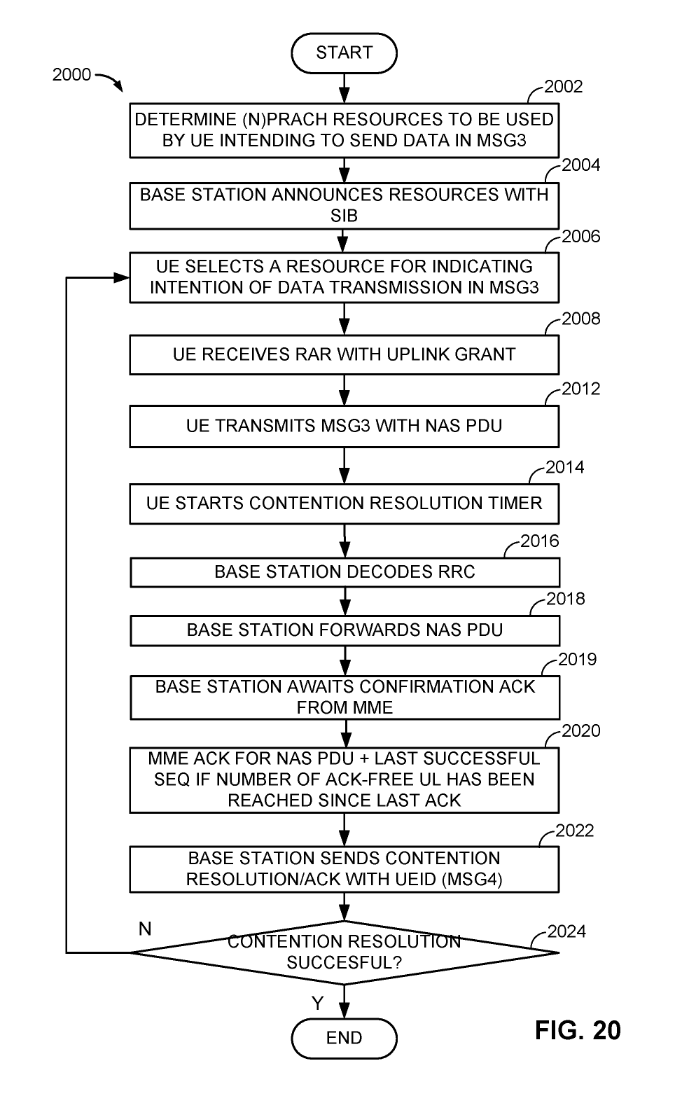

FIG. 20 is a flow chart illustrating an example of a method for communication, in accordance with various aspects of the present disclosure. The blocks in the method 2000 can be performed in or out of the order shown, and in some embodiments, can be performed at least in part in parallel. The blocks 2002 through 2016 in FIG. 20 are similar to the blocks 1802 through 1816 in FIG. 18.

In block 2002, a resource determination is made where the base station (eNB) 1006 allows transmission of packets up to certain size (e.g., up to 10 bytes, up to 20 bytes, as described above) without establishing full RRC connection. In an exemplary embodiment, the base station (eNB) 1006 allocates (N)PRACH resources for this purpose. Resources may also be different for different coverage enhancement (CE) levels.

In block 2004, a base station announces the available resources to a UE via a system information broadcast (SIB) message. In an exemplary embodiment, the base station (eNB) 1006 announces the available resources to the UE 1002 via a system information broadcast (SIB) message.

In block 2006, a UE selects a resource for data transmission. In an exemplary embodiment, the UE 1002 selects an (N)PRACH resource based on the announced resources and, optionally, the amount of data to transmit. The selection may be based on a random selection, or a deterministic allocation, as described above. The UE 1002 transmits the selected (N)PRACH preamble to the base station (eNB) 1006 using the first communication message, Msg1.

In block 2008, a UE receives a random access response (RAR) including a grant of uplink resources from a base station. In an exemplary embodiment, the UE 1002 receives a random access response (RAR) from the base station (eNB) 1006, as described herein.

In block 2012, a UE transmits data to a base station. For example, if the UE 1002 desires to send data to the base station (eNB) 1006, the UE 1002 transmits Msg3 with UE ID and NAS PDU (message 3, plus the UE ID, plus the NAS protocol data unit (data)) using the UL grant indicated in the RAR received from the base station (eNB) 1006 in block 2008.

In block 2014, a UE may start a contention resolution timer. For example, the contention resolution timer may be implemented using the controller/processor 659 in the exemplary UE 650 of FIG. 6).

In block 2016, a base station may attempt to decode an RRC message. For example, the base station (eNB) 1006 may decode the radio resource control (RRC) message received from the UE 1002.

In block 2018, a base station may forward the NAS PDU plus a sequence (SEQ) count to the MME. For example, the base station (eNB) 1006 includes a sequence (SEQ) count in the NAS PDU communication to the MME 1012. In an exemplary embodiment, a SEQ counter is incremented for each new NAS PDU. The MME 1012 keeps track of the SEQ count and knows if any packets are missing. For example, the SEQ counter may be implemented using the counter 663 and the controller/processor 659 in the exemplary UE 650 of FIG. 6.

In block 2019, a base station awaits a confirmation acknowledgement (ACK) from an MME. For example, the base station (eNB) 1006 awaits confirmation/ACK from the MME 1012 if the predetermined number of ACK-free packets has been reached since the last MME-ACK.

In block 2020, the MME 1012 sends an ACK along with the last successful SEQ if the number of ACK-free packets has been reached since the last MME-ACK. The last successful SEQ count can be used by the base station (eNB) 1006 to identify any irregularity or can be forwarded to the UE 1002 by the base station (eNB) 1006, which can be used by the UE 1002 to identify any irregularity or for retransmissions if needed.

In block 2022, the base station (eNB) 1006 sends the contention resolution/ACK message (e.g. using, for example, the MTC physical downlink control channel (MPDCCH) or physical downlink shared channel (PDSCH)) with the UE ID and the last successful SEQ in message 4, Msg4. The block 2022 serves as MME-ACK and confirms to the UE 1002 that the data successfully reached MME 1012. The block 2020 may not be performed for all sessions. The base station (eNB) 1006 is aware of when to expect MME-ACK from the MME 1012 (based on the initial negotiation of ACK-free UL), so it may proceed to block 2022 for the session with no MME-ACK. Further, the contention resolution timer for the session with ACK-free packets and packets requiring ACK may be different (due to additional S1 roundtrip time for the packets requiring MME-ACK).

In block 2024, it is determined whether the contention resolution was successful. If the contention resolution was successful, the process ends. If the contention resolution was not successful, the process returns to block 2006.

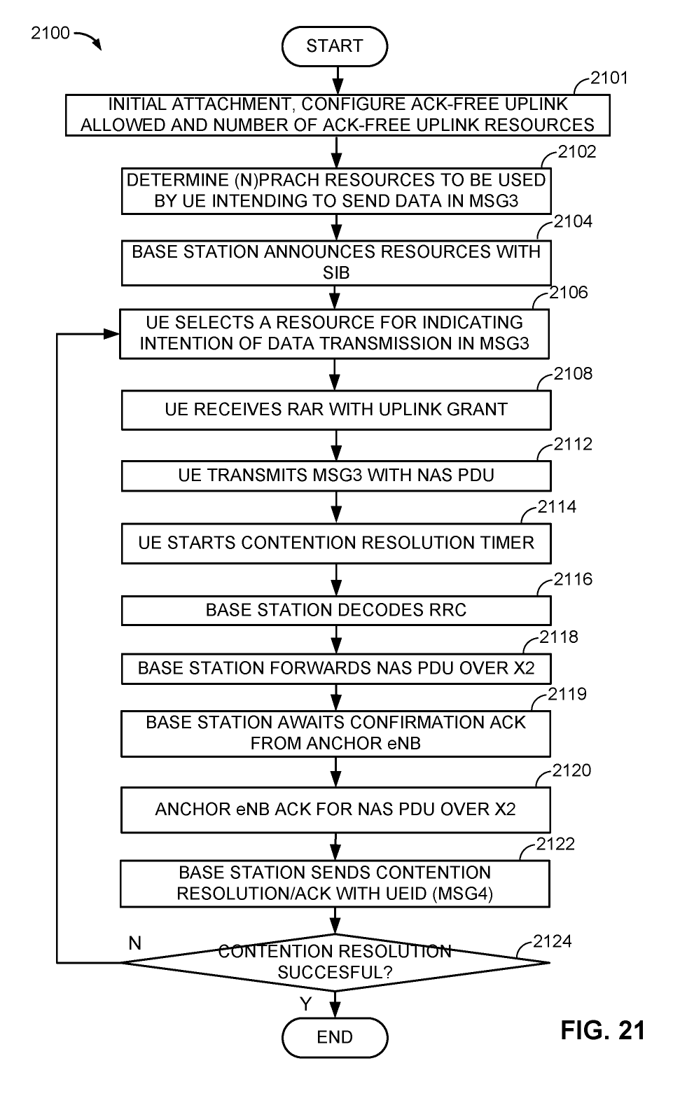

FIG. 21 is a flow chart illustrating an example of a method for communication, in accordance with various aspects of the present disclosure. The blocks in the method 2100 can be performed in or out of the order shown, and in some embodiments, can be performed at least in part in parallel. In FIG. 21, the base station (eNB) 1006 may be referred to as a “serving” base station, and a base station (eNB) 1306 may be referred to as an “anchor” base station.

In block 2101, an initial attachment of the UE 1002 to the serving base station (eNB) 1006 occurs with the base station (eNB) 1006 configuring the UE 1002 for ACK-free uplink and for the number of ACK-free packets allowed. In an exemplary embodiment, the anchor base station (eNB-1) 1306 stores the UE 1002 context including the radio access network (RAN) security context of the UE 1002.

In block 2102, a resource determination is made where the base station (eNB) 1006 allows transmission of packets up to certain size (e.g., up to 10 bytes, up to 20 bytes, etc., as described above) without establishing full RRC connection. In an exemplary embodiment, the base station (eNB) 1006 allocates (N)PRACH resources for this purpose. Resources may also be different for different coverage enhancement (CE) levels.

In block 2104, a base station announces the available resources to a UE via a system information broadcast (SIB) message. In an exemplary embodiment, the base station (eNB) 1006 announces the available resources to the UE 1002 via a system information broadcast (SIB) message.

In block 2106, a UE selects a resource for data transmission. In an exemplary embodiment, the UE 1002 selects an (N)PRACH resource based on the announced resources and, optionally, the amount of data to transmit. The selection may be based on a random selection, or a deterministic allocation, as described above. The UE 1002 transmits the selected (N)PRACH preamble to the base station (eNB) 1006 using the first communication message, Msg1.

In block 2108, a UE receives a random access response (RAR) including a grant of uplink resources from a base station. In an exemplary embodiment, the UE 1002 receives a random access response (RAR) from the base station (eNB) 1006, as described herein.

In block 2112, a UE transmits data to a base station. For example, if the UE 1002 desires to send data to the base station (eNB) 1006, the UE 1002 transmits Msg3 with UE ID and NAS PDU (message 3, plus the UE ID, plus the NAS protocol data unit (data)) using the UL grant indicated in the RAR received from the base station (eNB) 1006 in block 2108.

In block 2114, a UE may start a contention resolution timer. For example, the contention resolution timer may be implemented using the timer 663 and the controller/processor 659 in the exemplary UE 650 of FIG. 6.

In block 2116, a base station may attempt to decode an RRC message. For example, the eNB1006 may decode the radio resource control (RRC) message received from the UE 1002.

In block 2118, a base station may forward the NAS PDU to the anchor eNB 1306 over an X2 protocol, which is faster than the 51 protocol used to communicate with an MME.

In block 2119, a base station awaits a confirmation acknowledgement (ACK) from an anchor eNB. For example, the serving base station (eNB) 1006 awaits confirmation/ACK from the anchor base station (eNB-1) 1306.

In block 2120, the anchor base station (eNB-1) 1306 sends an ACK to the serving base station (eNB) 1006 for the NAS PDU communication sent in block 2118 over the X2 network connection.

In block 2122, the base station (eNB) 1006 sends the contention resolution message (e.g. using, for example, the MTC physical downlink control channel (MPDCCH) or physical downlink shared channel (PDSCH)) to the UE 1002 with the UE ID in message 4, Msg4. The message in block 2122 serves as MME-ACK and confirms to the UE 1002 that the data successfully reached the MME 1012.

In block 2124, it is determined whether the contention resolution was successful. If the contention resolution was successful, the process ends. If the contention resolution was not successful, the process returns to block 2106.

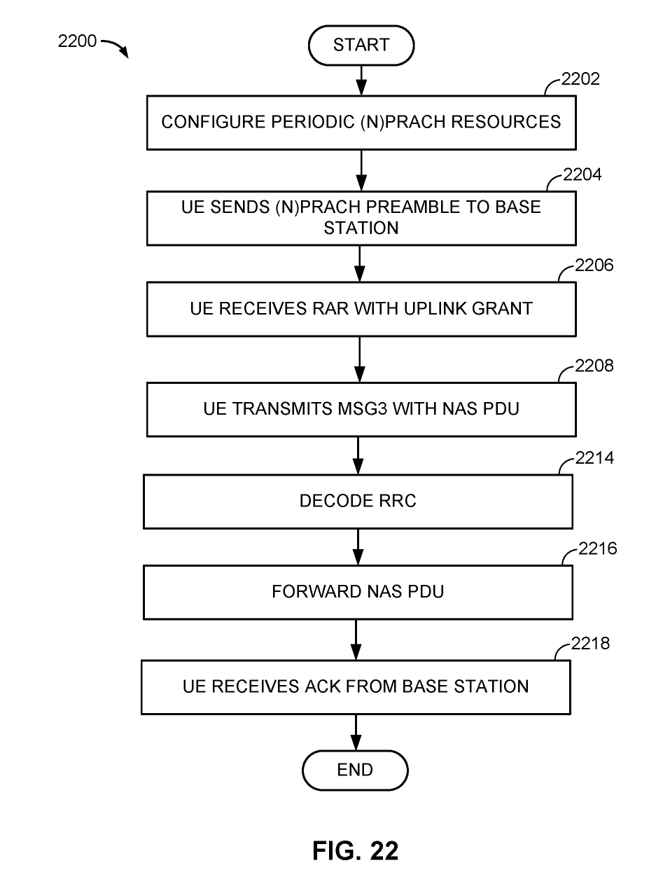

FIG. 22 is a flow chart illustrating an example of a method for communication, in accordance with various aspects of the present disclosure. The blocks in the method 2200 can be performed in or out of the order shown, and in some embodiments, can be performed at least in part in parallel.

In block 2202, the MME 1012 configures periodic (N)PRACH resources for the UE 1002. For example, the MME 1012 may configure a reserved (N)PRACH resource for the UE 1002 twice per day (or another period), with the resources identified using, for example, hyper frame number (HFN)/system frame number (SFN).

In block 2204, a UE sends an (N)PRACH preamble to a base station. For example, the UE 1002 transmits the selected (N)PRACH preamble to the base station (eNB) 1006 using the first communication message, Msg1.

In block 2206, a UE receives a random access response (RAR) including a grant of uplink resources from a base station. In an exemplary embodiment, the UE 1002 receives a random access response (RAR) from the base station (eNB) 1006, as described herein.

In block 2208, a UE transmits data to a base station. For example, if the UE 1002 desires to send data to the base station (eNB) 1006, the UE 1002 transmits Msg3 with UE ID and NAS PDU (message 3, plus the UE ID, plus the NAS protocol data unit (data)) using the UL grant indicated in the RAR received from the base station (eNB) 1006 in block 2206.

In block 2214, a base station may attempt to decode an RRC message. For example, the base station (eNB) 1006 may decode the radio resource control (RRC) message received from the UE 1002.

In block 2216, a base station may forward the NAS PDU to the MME. For example, the eNB1006 forwards the NAS PDU to the MME 1012. A new S1 message may be defined for this step. The S1 protocol is one used between a base station (eNB) and an MME.

In block 2218, a UE may receive an acknowledgement (ACK) from a base station. For example, the UE 1002 receives an acknowledgement (ACK) from the base station (eNB) 1006.

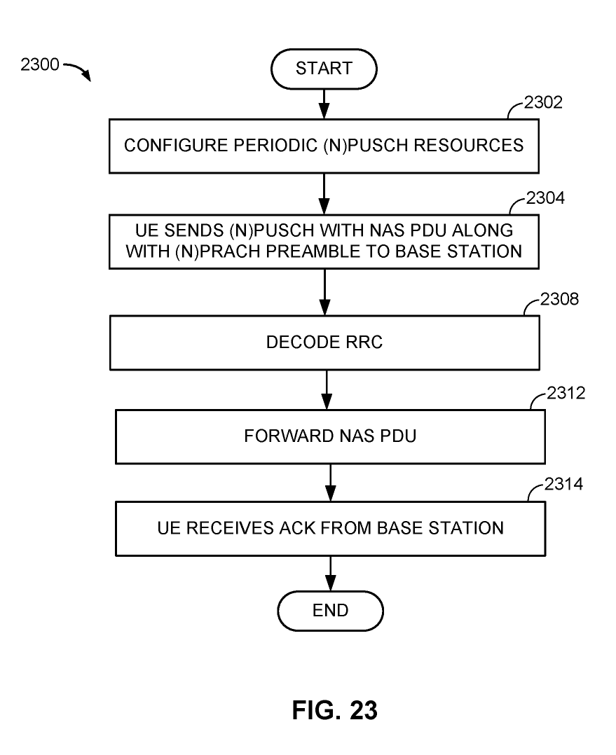

FIG. 23 is a flow chart illustrating an example of a method for communication, in accordance with various aspects of the present disclosure. The blocks in the method 2300 can be performed in or out of the order shown, and in some embodiments, can be performed at least in part in parallel.

In block 2302, the MME 1012 configures periodic (N)PUSCH resources for the UE 1002. For example, the MME 1012 may configure a reserved (N)PUSCH resource for the UE 1002 twice per day (or another periodicity), with the resources identified using, for example, hyper frame number (HFN)/system frame number (SFN).

In block 2304, a UE sends an (N)PUSCH preamble and the NAS PDU along with an (N)PRACH preamble to a base station. For example, the UE 1002 transmits the selected (N)PUSCH preamble and the NAS PDU with an (N)PRACH preamble to the base station (eNB) 1006 using a first communication message, which may be referred to as Msg1 in this exemplary embodiment.

In block 2308, a base station may attempt to decode an RRC message. For example, the base station (eNB) 1006 may decode the radio resource control (RRC) message received from the UE 1002.

In block 2312, a base station may forward the NAS PDU to the MME. For example, the eNB1006 forwards the NAS PDU to the MME 1012. A new S1 message may be defined for this step. The S1 protocol is one used between a base station (eNB) and an MME.

In block 2314, a UE may receive an acknowledgement (ACK) from a base station. For example, the UE 1002 receives an acknowledgement (ACK) from the base station (eNB) 1006.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. DMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over an unlicensed and/or shared bandwidth. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for communication, comprising:
sending communication data from a user equipment (UE) to a base station (eNB) during a random access procedure prior to establishment of a radio resource control (RRC) connection between the UE and the base station.

2. The method of claim 1, wherein the random access procedure comprises transmission of a communication preamble, wherein the communication preamble comprises at least one of a PRACH, an NPRACH, a PUSCH and an NPUSCH communication.

3. The method of claim 1, wherein the communication data is sent in one of a first message of the random access procedure and a third message of the random access procedure.

4. The method of claim 1, wherein the communication data is sent using a non-access stratum protocol data unit (NAS PDU) and is sent to a mobility management entity (MME).

5. The method of claim 1, wherein the UE communicates to the base station at least one of its ability and its intention to send the communication data during the random access procedure.

6. The method of claim 1, wherein the random access procedure comprises (N)PRACH resources that are allocated as contention-free resources based on a pre-configured pattern.

7. The method of claim 4, wherein one or more of the UE, the base station and the MME configure the transmission of a number of acknowledgement (ACK)-free communication packets.

8. The method of claim 4, further comprising a sequence (SEQ) count in the NAS PDU communication to the MME.

9. The method of claim 8, wherein the SEQ count allows the MME to acknowledge receipt of the NAS PDU every “N” NAS PDU communications.

10. The method of claim 8, wherein the SEQ count allows communication to continue without waiting for the MME to acknowledge each NAS PDU.

11. The method of claim 8, wherein prior to an expiration of a contention resolution timer associated with the SEQ count, allowing communication to continue without waiting for the MME to acknowledge the NAS PDU.

12. An apparatus for communication, comprising:
a user Equipment (UE) configured to send communication data to a base station (eNB) during a random access procedure prior to establishment of a radio resource control (RRC) connection between the UE and the base station.

13. The apparatus of claim 12, wherein the random access procedure comprises transmission of a communication preamble, wherein the communication preamble comprises at least one of a PRACH, an NPRACH, a PUSCH and an NPUSCH communication.

14. The apparatus of claim 12, wherein the communication data is sent in one of a first message of the random access procedure and a third message of the random access procedure.

15. The apparatus of claim 12, wherein the communication data is sent using a non-access stratum protocol data unit (NAS PDU) and is sent to a mobility management entity (MME) and the apparatus further comprises:
a sequence (SEQ) count in the NAS PDU communication to the MME, wherein the SEQ count allows the MME to acknowledge receipt of the NAS PDU every “N” NAS PDU communications.

16. The apparatus of claim 12, wherein the UE communicates to the base station at least one of its ability and its intention to send the communication data during the random access procedure.

17. The apparatus of claim 12, wherein the random access procedure comprises (N)PRACH resources that are allocated as contention-free resources based on a pre-configured pattern.

18. The apparatus of claim 13, further comprising:
a controller/processor associated with the UE, the controller/processor configured to organize the communication preamble into a communication sequence; and
a transmitter associated with the UE, the transmitter configured to send the communication sequence to a base station prior to the establishment of the RRC connection between the UE and the base station.

19. The apparatus of claim 15, wherein prior to an expiration of a contention resolution timer associated with the SEQ count, allowing communication to continue without waiting for the MME to acknowledge the NAS PDU.

20. The apparatus of claim 15, wherein one or more of the UE, the base station and the MME configure the transmission of a number of acknowledgement (ACK)-free communication packets.

21. A non-transitory computer-readable medium storing computer executable code for communication, the code executable by a processor to:
send communication data from a user equipment (UE) to a base station (eNB) during a random access procedure prior to establishment of a radio resource control (RRC) connection is between the UE and the base station.

22. The non-transitory computer-readable medium of claim 21, wherein the random access procedure comprises transmission of a communication preamble, wherein the communication preamble comprises at least one of a PRACH, an NPRACH, a PUSCH and an NPUSCH communication.

23. The non-transitory computer-readable medium of claim 21, wherein the code is executable by a processor to:
send the communication data in one of a first message of the random access procedure and a third message of the random access procedure.

24. The non-transitory computer-readable medium of claim 21, wherein the code is executable by a processor to:
send the communication data using a non-access stratum protocol data unit (NAS PDU) and to a mobility management entity (MME) and the apparatus further comprises:
a sequence (SEQ) count in the NAS PDU communication to the MME, wherein the SEQ count allows the MME to acknowledge receipt of the NAS PDU every “N” NAS PDU communications.

25. A method for a random access communication, comprising:
in a random access procedure, sending a first communication message from a user equipment (UE) to a base station (eNB);
in the random access procedure, receiving from the base station a second communication message having an uplink communication grant defining a communication data resource; and
in the random access procedure, sending in a third communication message from the UE, communication data using the defined communication data resource prior to the establishment of a radio resource communication (RRC) link.

26. The method of claim 25, wherein the first communication message is sent in a random access procedure comprising transmission of a communication preamble, wherein the communication preamble comprises at least one of a PRACH, an NPRACH, a PUSCH and an NPUSCH communication.

27. The method of claim 26, wherein the communication data is sent using a non-access stratum protocol data unit (NAS PDU) and is sent to a mobility management entity (MME) and the method further comprises:
including a sequence (SEQ) count in the NAS PDU communication to the MME, wherein the SEQ count allows the MME to acknowledge receipt of the NAS PDU every “N” NAS PDU communications.

28. The method of claim 27, wherein the SEQ count allows communication to continue without waiting for the MME to acknowledge each NAS PDU.

29. The method of claim 27, wherein prior to an expiration of a contention resolution timer associated with the SEQ count, allowing communication to continue without waiting for the MME to acknowledge the NAS PDU.
